(19) United States
(12) Patent Application Publication
(10) Pub. No.: US 2026/0262007 A1
(43) Pub. Date: Sep. 3, 2026

(54) CARRIER PHASE CONFIGURATION, POSITIONING AND MEASUREMENT

(71) Applicant: LENOVO (SINGAPORE) PTE. LTD., Singapore (SG)

(72) Inventors: Colin FRANK, Park Ridge, IL (US); Robin Rajan THOMAS, Bad Nauheim (DE)

(21) Appl. No.: 19/154,644

(22) PCT Filed: Jan. 24, 2024
(86) PCT No.: PCT/IB2024/050673

§ 371 Date: Aug. 7, 2025

Related U.S. Application Data
(60) Provisional application No. 63/485,472, filed on Feb. 16, 2023.

(51) Int. Cl. H04W 64/00; H04L 5/00

(52) U.S. Cl. CPC H04W 64/00; H04L 5/0098

(57) ABSTRACT

Various aspects of the present disclosure relate to non-contiguous configurations for positioning reference signals used to measure phase. In an implementation, a user equipment includes a processor and a transceiver coupled to the processor, and the processor is configured to receive a carrier phase configuration from a network entity, the carrier phase configuration including parameters for a plurality of non-contiguous positioning reference signals, receive the plurality of non-contiguous positioning reference signals, measure carrier phase of the plurality of non-contiguous positioning reference signals, and transmit the carrier phase measurements to the network entity.

### TECHNICAL FIELD

The present disclosure relates to wireless communications, and more specifically to configuring and processing reference signals for carrier phase measurements.

### BACKGROUND

A wireless communications system may include one or multiple network communication devices, such as base stations, which may be otherwise known as an eNodeB (eNB), a next-generation NodeB (gNB), or other suitable terminology. Each network communication devices, such as a base station may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

Device positioning is an increasingly important element of wireless communication devices. Device positioning is very useful for technologies such as automated or semi-automated vehicle piloting, in which devices may exchange position information and determine appropriate pathing based on the exchanged information. If the positioning information is not accurate, the vehicles could collide with one another.

While wireless networks employ various positioning technologies, many of those technologies rely on sub-optimal provisioning of contiguous positioning reference signal Physical Resource Blocks (PRBs), limiting spectral efficiency.

### SUMMARY

The present disclosure relates to methods, apparatuses, and systems that support non-contiguous provisioning of positioning reference signals for phase measurements.

Some implementations of the method and apparatuses described herein may further include an apparatus for wireless communication, comprising a processor and a memory coupled with the processor, the processor configured to receive a carrier phase configuration from a network entity, the carrier phase configuration including parameters to configure a plurality of positioning reference signals in a non-contiguous manner, receive a plurality of carrier phase measurements based on the received carrier phase configuration, and transmit a report of the received carrier phase measurements to the network entity.

Some implementations of the method and apparatuses described herein may further include an apparatus for wireless communication, comprising a processor and a memory coupled with the processor, the processor configured to transmit a request for recommended non-contiguous configurations for positioning reference signals to a plurality of transmission-reception points, receive the recommended non-contiguous configurations from the plurality of transmission-reception points, provide a carrier phase configuration based on the recommended non-contiguous configurations, transmit the carrier phase configuration to the plurality of transmission-reception points, and receive a report of carrier phase measurements of the positioning reference signals from the plurality of transmission-reception points.

Some implementations of the method and apparatuses described herein may further include an apparatus for wireless communication, comprising a processor, and a memory coupled with the processor, the processor configured to receive a carrier phase configuration from a network entity, the carrier phase configuration including parameters for a plurality of non-contiguous positioning reference signals, receive the plurality of non-contiguous positioning reference signals, measure carrier phase of the plurality of non-contiguous positioning reference signals, and transmit the carrier phase measurements to the entity.

Embodiments of the present application extend to methods performed by the apparatuses discussed above and further explained in the disclosure below.

In some implementations of the method and apparatuses described herein, the carrier phase measurements comprise at least one of a subcarrier phase difference, and a delay based on a subcarrier phase difference.

In some implementations of the method and apparatuses described herein, the carrier phase configuration indicates an outermost set of positioning reference signal pairs within a bandwidth in which carrier phase is measured.

In some implementations of the method and apparatuses described herein, the outermost set of positioning reference signal pairs includes a pair of physical resource blocks (PRBs) at a highest frequency and a lowest frequency of the bandwidth.

In some implementations of the method and apparatuses described herein, the carrier phase configuration further indicates an innermost set of positioning reference signal pairs within the bandwidth in which carrier phase is measured.

In some implementations of the method and apparatuses described herein, the innermost set of positioning reference signal pairs are spaced apart from the outermost set of positioning reference signal pairs in the frequency domain.

In some implementations of the method and apparatuses described herein, the carrier phase configuration indicates a frequency separation between the outermost set of positioning reference signal pairs.

In some implementations of the method and apparatuses described herein, the frequency separation between the innermost sets of positioning reference signals is at least ⅓ of the frequency separation between the outermost sets of positioning reference signals.

In some implementations of the method and apparatuses described herein, a network entity, e.g. a gNB, transmits the outermost set of positioning reference signal pairs to a receiver; and transmits at least one data PRB at a frequency within a bandwidth of the frequency separation to the receiver.

In some implementations of the method and apparatuses described herein, the carrier phase configuration includes an indication to measure carrier phase of positioning reference signals received simultaneously from at least two different transmitters.

### BRIEF DESCRIPTION OF THE DRAWINGS

FIG. 1 illustrates an example of a wireless communications system that supports configuring and processing reference signals for carrier phase measurements in accordance with aspects of the present disclosure.

FIG. 2 illustrates an example of beam positioning in an NR network.

FIG. 3 illustrates an example of a multi-cell round-trip time (RTT) procedure in a wireless network.

FIG. 4 illustrates an example of relative range estimation using RTT and a single gNB.

FIG. 5 illustrates an example of a comb-6 PRS PRB.

FIG. 6 illustrates an example of a set of PRS PRBs that are contiguous in the frequency domain.

FIG. 7 illustrates a graph of SNR of PRS pairs vs. distance from the edge for 100 PRBs with two PRS per PRB.

FIG. 8 illustrates a graph of SNR vs. number of PRS pairs for 100 PRBs with two PRS per PRB.

FIG. 9 illustrates an example of non-contiguous sets of PRS pairs for measuring delay and phase wrapping that supports configuring and processing reference signals for carrier phase measurements in accordance with aspects of the present disclosure.

FIG. 10A illustrates an example of two sets of 10 outermost PRS PRB pairs for measuring delay in a block of 50 PRBs, and FIG. 10B illustrates an example of two sets of 2 outermost PRS PRB pairs for measuring delay in a block of 100 PRBs that supports configuring and processing reference signals for carrier phase measurements in accordance with aspects of the present disclosure.

FIG. 11 illustrates an example of a block diagram of a device that supports configuring and processing reference signals for carrier phase measurements in accordance with aspects of the present disclosure.

FIG. 12 illustrates a flowchart of a method that supports configuring and processing reference signals for carrier phase measurements in accordance with aspects of the present disclosure.

FIG. 13 illustrates an information element that supports configuring and processing reference signals for carrier phase measurements in accordance with aspects of the present disclosure.

FIGS. 14 and 15 illustrate flowcharts of methods that support configuring and processing reference signals for carrier phase measurements in accordance with aspects of the present disclosure.

FIG. 16 illustrates an embodiment of a processor that supports configuring and processing reference signals for carrier phase measurements in accordance with aspects of the present disclosure.

### DETAILED DESCRIPTION

There is significant overhead associated with the transmission of positioning reference signals (PRS). At least from the perspective of carrier phase measurements, the PRS in the middle of the bandwidth configured for transmitting PRS have minimal value. Currently, only contiguous PRS PRB allocations are defined for the enhanced positioning work item. Currently, the specific methods for measuring the carrier phase slope/delay/range are not specified.

This disclosure considers non-contiguous allocations of PRS PRBs that reduce overhead without reducing the accuracy of carrier phase measurements.

Based on the analysis in this disclosure, it is proposed that that the PRS PRBs need not be configured contiguously, so that a configurable gap is allowed in the middle of the bandwidth configured for transmitting PRS. Methods for signaling non-contiguous PRS PRB configurations are proposed. Optimal and near-optimal methods are proposed for computing the phase slope or equivalently the delay and the range and reporting requirements are also proposed. Outermost pairs of PRBs can be configured for measuring delay, while one or more set of innermost PRB pairs can be configured for measuring phase wrapping.

Embodiments of the present disclosure increase spectral efficiency of a network performing phase measurements without significantly degrading the quality of positioning using the phase measurements.

Aspects of the present disclosure are described in the context of a wireless communications system. Aspects of the present disclosure are further illustrated and described with reference to device diagrams and flowcharts.

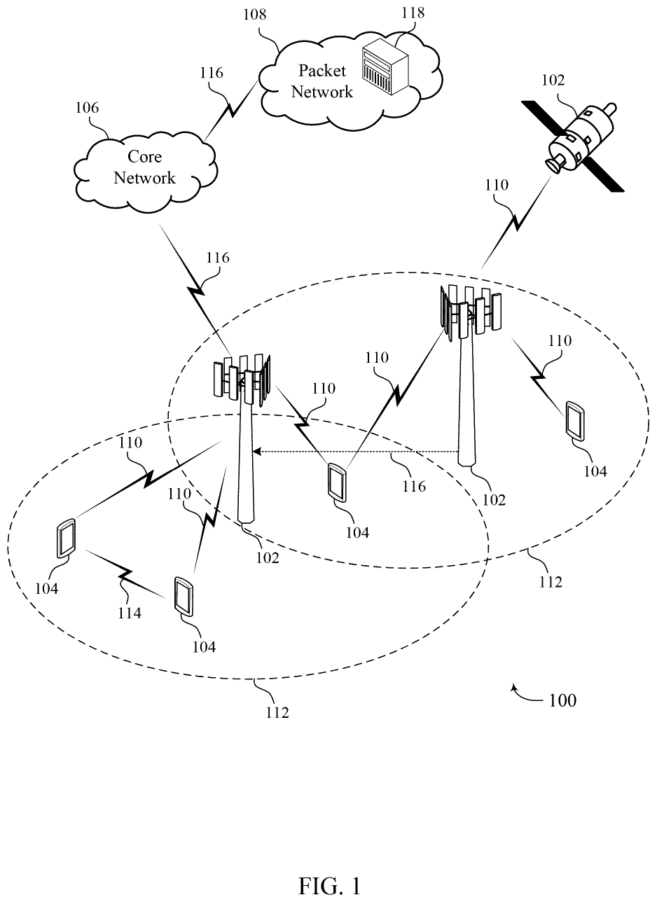

FIG. 1 illustrates an example of a wireless communications system 100 that supports configuring and processing reference signals for carrier phase measurements in accordance with aspects of the present disclosure. The wireless communications system 100 may include one or more network entities 102, one or more UEs 104, a core network 106, and a packet data network 108. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a 5G network, such as an NR network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G. Additionally, the wireless communications system 100 may support technologies, such as time division multiple access (TDMA), frequency division multiple access (FDMA), or code division multiple access (CDMA), etc.

The one or more network entities 102 may be dispersed throughout a geographic region to form the wireless communications system 100. One or more of the network entities 102 described herein may be or include or may be referred to as a network node, a base station, a network element, a radio access network (RAN), a base transceiver station, an access point, a NodeB, an eNodeB (eNB), a next-generation NodeB (gNB), or other suitable terminology. A network entity 102 and a UE 104 may communicate via a communication link 110, which may be a wireless or wired connection. For example, a network entity 102 and a UE 104 may perform wireless communication (e.g., receive signaling, transmit signaling) over a Uu interface.

A network entity 102 may provide a geographic coverage area 112 for which the network entity 102 may support services (e.g., voice, video, packet data, messaging, broadcast, etc.) for one or more UEs 104 within the geographic coverage area 112. For example, a network entity 102 and a UE 104 may support wireless communication of signals related to services (e.g., voice, video, packet data, messaging, broadcast, etc.) according to one or multiple radio access technologies. In some implementations, a network entity 102 may be moveable, for example, a satellite associated with a non-terrestrial network. In some implementations, different geographic coverage areas 112 associated with the same or different radio access technologies may overlap, but the different geographic coverage areas 112 may be associated with different network entities 102. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 104 may be dispersed throughout a geographic region of the wireless communications system 100. A UE 104 may include or may be referred to as a mobile device, a wireless device, a remote device, a remote unit, a handheld device, or a subscriber device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples. In some implementations, a UE 104 may be stationary in the wireless communications system 100. In some other implementations, a UE 104 may be mobile in the wireless communications system 100.

The one or more UEs 104 may be devices in different forms or having different capabilities. Some examples of UEs 104 are illustrated in FIG. 1. A UE 104 may be capable of communicating with various types of devices, such as the network entities 102, other UEs 104, or network equipment (e.g., the core network 106, the packet data network 108, a relay device, an integrated access and backhaul (IAB) node, or another network equipment), as shown in FIG. 1. Additionally, or alternatively, a UE 104 may support communication with other network entities 102 or UEs 104, which may act as relays in the wireless communications system 100.

A UE 104 may also be able to support wireless communication directly with other UEs 104 over a communication link 114. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 114 may be referred to as a sidelink. For example, a UE 104 may support wireless communication directly with another UE 104 over a PC5 interface.

A network entity 102 may support communications with the core network 106, or with another network entity 102, or both. For example, a network entity 102 may interface with the core network 106 through one or more backhaul links 116 (e.g., via an S1, N2, or another network interface). The network entities 102 may communicate with each other over the backhaul links 116 (e.g., via an X2, Xn, or another network interface). In some implementations, the network entities 102 may communicate with each other directly (e.g., between the network entities 102). In some other implementations, the network entities 102 may communicate with each other or indirectly (e.g., via the core network 106). In some implementations, one or more network entities 102 may include subcomponents, such as an access network entity, which may be an example of an access node controller (ANC). An ANC may communicate with the one or more UEs 104 through one or more other access network transmission entities, which may be referred to as radio heads, smart radio heads, or transmission-reception points (TRPs).

In some implementations, a network entity 102 may be configured in a disaggregated architecture, which may be configured to utilize a protocol stack physically or logically distributed among two or more network entities 102, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 102 may include one or more of a central unit (CU), a distributed unit (DU), a radio unit (RU), a RAN Intelligent Controller (RIC) (e.g., a Near-Real Time RIC (Near-RT RIC), a Non-Real Time RIC (Non-RT RIC)), a Service Management and Orchestration (SMO) system, or any combination thereof.

An RU may also be referred to as a radio head, a smart radio head, a remote radio head (RRH), a remote radio unit (RRU), or a transmission reception point (TRP). One or more components of the network entities 102 in a disaggregated RAN architecture may be co-located, or one or more components of the network entities 102 may be located in distributed locations (e.g., separate physical locations). In some implementations, one or more network entities 102 of a disaggregated RAN architecture may be implemented as virtual units (e.g., a virtual CU (VCU), a virtual DU (VDU), a virtual RU (VRU)).

Split of functionality between a CU, a DU, and an RU may be flexible and may support different functionalities depending upon which functions (e.g., network layer functions, protocol layer functions, baseband functions, radio frequency functions, and any combinations thereof) are performed at a CU, a DU, or an RU. For example, a functional split of a protocol stack may be employed between a CU and a DU such that the CU may support one or more layers of the protocol stack and the DU may support one or more different layers of the protocol stack. In some implementations, the CU may host upper protocol layer (e.g., a layer 3 (L3), a layer 2 (L2)) functionality and signaling (e.g., Radio Resource Control (RRC), service data adaption protocol (SDAP), Packet Data Convergence Protocol (PDCP)). The CU may be connected to one or more DUsor RUs, and the one or more DUs or RUs may host lower protocol layers, such as a layer 1 (L1) (e.g., physical (PHY) layer) or an L2 (e.g., radio link control (RLC) layer, medium access control (MAC) layer) functionality and signaling, and may each be at least partially controlled by the CU 160.

Additionally, or alternatively, a functional split of the protocol stack may be employed between a DU and an RU such that the DU may support one or more layers of the protocol stack and the RU may support one or more different layers of the protocol stack. The DU may support one or multiple different cells (e.g., via one or more RUs). In some implementations, a functional split between a CU and a DU, or between a DU and an RU may be within a protocol layer (e.g., some functions for a protocol layer may be performed by one of a CU, a DU, or an RU, while other functions of the protocol layer are performed by a different one of the CU, the DU, or the RU).

A CU may be functionally split further into CU control plane (CU-CP) and CU user plane (CU-UP) functions. A CU may be connected to one or more DUs via a midhaul communication link (e.g., F1, F1-c, F1-u), and a DU may be connected to one or more RUs via a fronthaul communication link (e.g., open fronthaul (FH) interface). In some implementations, a midhaul communication link or a fronthaul communication link may be implemented in accordance with an interface (e.g., a channel) between layers of a protocol stack supported by respective network entities 102 that are in communication via such communication links.

The core network 106 may support user authentication, access authorization, tracking, connectivity, and other access, routing, or mobility functions. The core network 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more network entities 102 associated with the core network 106.

The core network 106 may communicate with the packet data network 108 over one or more backhaul links 116 (e.g., via an S1, N2, or another network interface). The packet data network 108 may include an application server 118. In some implementations, one or more UEs 104 may communicate with the application server 118. A UE 104 may establish a session (e.g., a protocol data unit (PDU) session, or the like) with the core network 106 via a network entity 102. The core network 106 may route traffic (e.g., control information, data, and the like) between the UE 104 and the application server 118 using the established session (e.g., the established PDU session). The PDU session may be an example of a logical connection between the UE 104 and the core network 106 (e.g., one or more network functions of the core network 106).

In the wireless communications system 100, the network entities 102 and the UEs 104 may use resources of the wireless communication system 100 (e.g., time resources (e.g., symbols, slots, subframes, frames, or the like) or frequency resources (e.g., subcarriers, carriers)) to perform various operations (e.g., wireless communications). In some implementations, the network entities 102 and the UEs 104 may support different resource structures. For example, the network entities 102 and the UEs 104 may support different frame structures. In some implementations, such as in 4G, the network entities 102 and the UEs 104 may support a single frame structure. In some other implementations, such as in 5G and among other suitable radio access technologies, the network entities 102 and the UEs 104 may support various frame structures (i.e., multiple frame structures). The network entities 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the network entities 102 and the UEs 104 may perform wireless communications over one or more of the operating frequency bands. In some implementations, FR1 may be used by the network entities 102 and the UEs 104, among other equipment or devices for cellular communications traffic (e.g., control information, data). In some implementations, FR2 may be used by the network entities 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

Positioning techniques supported in Rel-16 are listed in the following Table 1:

TABLE 1

| | | | NG-RAN | |
|---|---|---|---|---|
| | | UE-assisted, | node | |
| Method | UE-based | LMF-based | assisted | SUPL |
| A-GNSS | Yes | Yes | No | Yes (UE-based and |
| | | | | UE-assisted) |
| OTDOA *^{,}** | No | Yes | No | Yes (UE-assisted) |
| E-CID *** | No | Yes | Yes | Yes for E-UTRA |
| | | | | (UE-assisted) |
| Sensor | Yes | Yes | No | No |
| WLAN | Yes | Yes | No | Yes |
| Bluetooth | No | Yes | No | No |
| TBS **** | Yes | Yes | No | Yes (MBS) |
| DL-TDOA | Yes | Yes | No | No |
| DL-AoD | Yes | Yes | No | No |
| Multi-RTT | No | Yes | Yes | No |
| NR E-CID | No | Yes | FFS | No |
| UL-TDOA | No | No | Yes | No |
| UL-AoA | No | No | Yes | No |

* This includes TBS positioning based on PRS signals.
** In this version of the specification only OTDOA based on LTE signals is supported.
*** This includes Cell-ID for NR method.
**** In this version of the specification only for TBS positioning based on MBS signals.

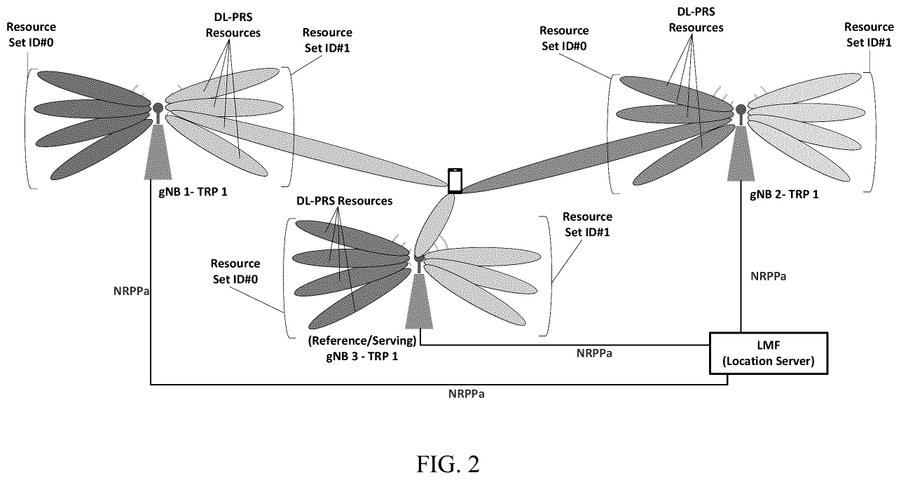

Separate positioning techniques as indicated in Table 1 can be configured and performed based on the requirements of the Location Management Function (LMF) and UE capabilities. The transmission of Uu (uplink and downlink) Positioning Reference Signals (PRS) enable the UE to perform UE positioning-related measurements to enable the computation of a UE's absolute location estimate and are configured per Transmission Reception Point (TRP), where a TRP may include a set of one or more beams. A conceptual overview is illustrated in FIG. 2.

The PRS can be transmitted by different base stations (serving and neighboring) using narrow beams over FR1 and FR2 as illustrated in FIG. 2, which is relatively different when compared to LTE where the PRS was transmitted across the whole cell. The PRS can be locally associated with a PRS Resource ID and Resource Set ID for a base station (TRP). Similarly, UE positioning measurements such as Reference Signal Time Difference (RSTD) and PRS RSRP measurements are made between beams (e.g., between a different pair of DL PRS resources or DL PRS resource sets) as opposed to different cells as was the case in LTE. In addition, there are additional UL positioning methods for the network to exploit in order to compute the target UE's location.

Table 2 and Table 3 show reference signal to measurements mapping for each of the supported RAT-dependent positioning techniques at the UE and gNB, respectively. RAT-dependent positioning techniques involve the 3GPP RAT and core network entities to perform the position estimation of the U, which are differentiated from RAT-independent positioning techniques which rely on GNSS, IMU sensor, WLAN and Bluetooth technologies for performing target device (UE) positioning.

TABLE 2
UE measurements to enable RAT-dependent positioning techniques

| | | To facilitate support |
|---|---|---|
| DL/UL Reference | UE | of the following |
| Signals | Measurements | positioning techniques |
| Rel. 16 DL PRS | DL RSTD | DL-TDOA |
| Rel.16 DL PRS | DL PRS RSRP | DL-TDOA, DL-AOD, |
| | | Multi-RTT |
| Rel. 16 DL PRS/ | UE Rx-Tx time | Multi-RTT |
| Rel.16 SRS for | difference | |
| positioning | | |
| Rel. 15 SSB/CSI-RS | SS-RSRP(RSRP for | E-CID |
| for RRM | RRM), SS-RSRQ(for | |
| | RRM), CSI-RSRP (for | |
| | RRM), CSI-RSRQ (for | |
| | RRM), SS-RSRPB | |
| | (for RRM) | |

TABLE 3
gNB measurements to enable RAT-dependent
positioning techniques

| | | To facilitate support |
|---|---|---|
| DL/UL Reference | gNB | of the following |
| Signals | Measurements | positioning techniques |
| Rel.16 SRS for | UL RTOA | UL-TDOA |
| positioning | | |
| Rel.16 SRS for | UL SRS-RSRP | UL-TDOA, UL-AoA, |
| positioning | | Multi-RTT |
| Rel.16 SRS for | gNB Rx-Tx time | Multi-RTT |
| positioning, | difference | |
| Rel.16 DL PRS | | |
| Rel.16 SRS for | AoA and ZoA | UL-AoA, Multi-RTT |
| positioning | | |

Downlink Time Difference of Arrival (DL-TDOA) positioning makes use of the DL RSTD (and optionally DL PRS RSRP) of downlink signals received from multiple transmission points (TP)s, at the UE. The UE measures the DL RSTD (and optionally DL PRS RSRP) of the received signals using assistance data received from the positioning server, and the resulting measurements are used along with other configuration information to locate the UE in relation to the neighboring TPs.

Downlink Angle of Departure (DL AoD) positioning makes use of the measured DL PRS RSRP of downlink signals received from multiple TPs, at the UE. The UE measures the DL PRS RSRP of the received signals using assistance data received from the positioning server, and the resulting measurements are used along with other configuration information to locate the UE in relation to the neighboring TPs.

Multiple Round Trip Time (Multi-RTT) positioning uses UE reception and transmission (Rx-Tx) measurements and DL PRS RSRP of downlink signals received from multiple Transmission and Reception Points (TRP)s, measured by the UE and measured gNB Rx-Tx measurements and UL SRS-RSRP at multiple TRPs of uplink signals transmitted from UE.

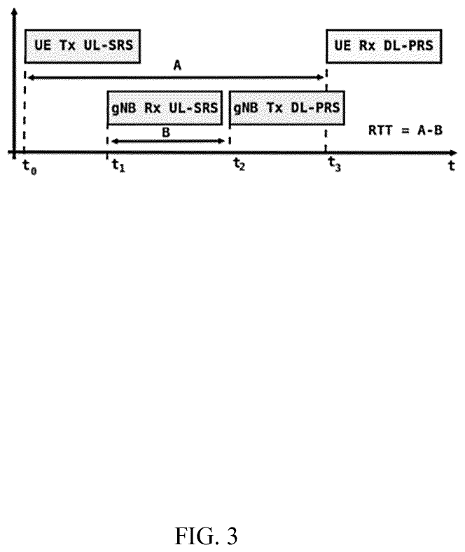

The UE measures the UE Rx-Tx measurements (and optionally DL PRS RSRP of the received signals) using assistance data received from the positioning server, and the TRPs measure the gNB Rx-Tx measurements (and optionally UL SRS-RSRP of the received signals) using assistance data received from the positioning server. The measurements are used to determine the RTT at the positioning server which are used to estimate the location of the UE (See FIG. 3). Multi-RTT is currently only supported for UE-assisted/NG-RAN assisted positioning techniques as noted in Table 1.

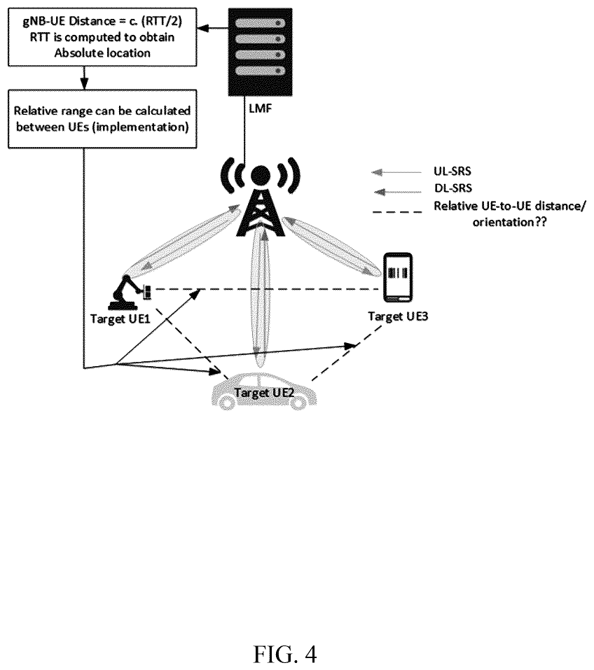

FIG. 4 illustrates computation of a RTT. A UE transmits an UpLink Sounding Reference Signal (UL-SRS) at time t0. A TRS (in FIG. 4, a New Radio NodeB gNB) receives the UL-SRS at time t1, and in response transmits a DownLink SRS (DL-SRS) at time t2. The UE receives the DL-SRS at time t3. The RTT may be computes as the time A between the transmission of the UL-SRS at time t0 and the reception of the DL-SRS at time t3, minus the time between the reception of the UL-SRS at time t1 and the transmission of the DL-SRS at time t2; that is, RTT=(t3−t0)−(t2−t1).

FIG. 3 is an illustration of an implementation-based approach to compute the relative distance between two UEs. This approach is high in latency and is not an efficient method in terms of procedures and signaling overhead.

For Enhanced Cell ID (CID) positioning, the position of a UE is estimated with the knowledge of its serving ng-eNB, gNB and cell and is based on LTE signals. The information about the serving ng-eNB, gNB and cell may be obtained by paging, registration, or other methods. NR Enhanced Cell ID (NR E CID) positioning refers to techniques which use additional UE measurements and/or NR radio resource and other measurements to improve the UE location estimate using NR signals.

Although NR E-CID positioning may utilize some of the same measurements as the measurement control system in the RRC protocol, the UE generally is not expected to make additional measurements for the sole purpose of positioning; the positioning procedures do not supply a measurement configuration or measurement control message, and the UE reports the measurements that it has available rather than being required to take additional measurement actions.

Uplink Time Difference of Arrival (UL TDOA) positioning makes use of the UL TDOA (and optionally UL SRS-RSRP) at multiple RPs of uplink signals transmitted from UE. The RPs measure the UL TDOA (and optionally UL SRS-RSRP) of the received signals using assistance data received from the positioning server, and the resulting measurements are used along with other configuration information to estimate the location of the UE.

Uplink Angle of Arrival (UL AoA) positioning makes use of the measured azimuth and the zenith of arrival at multiple RPs of uplink signals transmitted from UE. The RPs measure A-AoA and Z-AoA of the received signals using assistance data received from the positioning server, and the resulting measurements are used along with other configuration information to estimate the location of the UE.

In addition, several RAT-Independent positioning techniques are available, examples of which are described in TS38.305.

For example, Network-assisted GNSS techniques make use of UEs that are equipped with radio receivers capable of receiving GNSS signals. In 3GPP specifications the term GNSS encompasses both global and regional/augmentation navigation satellite systems. Examples of global navigation satellite systems include GPS, Modernized GPS, Galileo, GLONASS, and BeiDou Navigation Satellite System (BDS). Regional navigation satellite systems include Quasi Zenith Satellite System (QZSS) while the many augmentation systems, are classified under the generic term of Space Based Augmentation Systems (SBAS) and provide regional augmentation services. Different GNSSs (e.g., GPS, Galileo, etc.) can be used separately or in combination to determine the location of a UE.

Barometric pressure sensor positioning makes use of barometric sensors to determine the vertical component of the position of the UE. The UE measures barometric pressure, optionally aided by assistance data, to calculate the vertical component of its location or to send measurements to the positioning server for position calculation. Barometric positioning is combined with other positioning methods to determine the 3D position of a UE.

Wireless Local Access Network (WLAN) positioning makes use of WLAN measurements (e.g. Access Point (AP) identifiers and optionally other measurements) and databases to determine the location of the UE. The UE measures received signals from WLAN access points, optionally aided by assistance data, to send measurements to the positioning server for position calculation. Using the measurement results and a references database, the location of the UE is calculated. Alternatively, the UE may use WLAN measurements and optionally WLAN AP assistance data provided by the positioning server, to determine its location.

Bluetooth positioning makes use of Bluetooth measurements (beacon identifiers and optionally other measurements) to determine the location of the UE. The UE measures received signals from Bluetooth beacons. Using the measurement results and a references database, the location of the UE is calculated. The Bluetooth methods may be combined with other positioning methods (e.g., WLAN) to improve positioning accuracy of the UE.

A Terrestrial Beacon System (TBS) includes a network of ground-based transmitters, broadcasting signals for positioning purposes for TBS positioning. The current type of TBS positioning signals are the MBS (Metropolitan Beacon System) signals and Positioning Reference Signals (PRS). The UE measures received TBS signals, optionally aided by assistance data, to calculate its location or to send measurements to the positioning server for position calculation.

Motion sensor positioning makes use of different sensors such as accelerometers, gyros, magnetometers, to calculate the displacement of UE. The UE estimates a relative displacement based upon a reference position and/or reference time. UE sends a report comprising the determined relative displacement which can be used to determine the absolute position. This method may be used with other positioning methods for hybrid positioning.

The different DL measurements including DL PRS-RSRP, DL RSTD and UE Rx-Tx Time Difference required for the supported RAT-dependent positioning techniques are shown in Table 4. The following measurement configurations are specified [TS38.215]:
4 Pair of DL RSTD measurements can be performed per pair of cells. Each measurement is performed between a different pair of DL PRS Resources/Resource Sets with a single reference timing.
8 DL PRS RSRP measurements can be performed on different DL PRS resources from the same cell.

TABLE 4
DL PRS reference signal received power (DL PRS-RSRP)

| | |
|---|---|
| Definition | DL PRS reference signal received power (DL PRS-RSRP), is the linear average |
| | over the power contributions (in [W]) of the resource elements that carry DL |
| | PRS reference signals configured for RSRP measurements within the |
| | considered measurement frequency bandwidth. |
| | For frequency range 1, the reference point for the DL PRS-RSRP shall be the |
| | antenna connector of the UE. For frequency range 2, DL PRS-RSRP shall be |
| | measured based on the combined signal from antenna elements corresponding |
| | to a given receiver branch. For frequency range 1 and 2, if receiver diversity is |
| | in use by the UE, the reported DL PRS-RSRP value shall not be lower than the |
| | corresponding DL PRS-RSRP of any of the individual receiver branches. |
| Applicable | RRC_CONNECTED intra-frequency, |
| for | RRC_CONNECTED inter-frequency |

DL reference signal time difference (DL RSTD)

| | |
|---|---|
| Definition | DL reference signal time difference (DL RSTD) is the DL relative timing |
| | difference between the positioning node j and the reference positioning node i, |
| | defined as TSubframeRxj - TSubframeRxi, |
| | Where: |
| | TSubframeRxj is the time when the UE receives the start of one subframe from |
| | positioning node j. |
| | TSubframeRxi is the time when the UE receives the corresponding start of one |
| | subframe from positioning node i that is closest in time to the subframe received |
| | from positioning node j. |
| | Multiple DL PRS resources can be used to determine the start of one subframe |
| | from a positioning node. |
| | For frequency range 1, the reference point for the DL RSTD shall be the |
| | antenna connector of the UE. For frequency range 2, the reference point for the |
| | DL RSTD shall be the antenna of the UE. |
| Applicable | RRC_CONNECTED intra-frequency |
| for | RRC_CONNECTED inter-frequency |

UE Rx-Tx time difference

| | |
|---|---|
| Definition | The UE Rx - Tx time difference is defined as TUE-RX - TUE-TX |
| | Where: |
| | TUE-RX is the UE received timing of downlink subframe #i from a positioning |
| | node, defined by the first detected path in time. |
| | TUE-TX is the UE transmit timing of uplink subframe #j that is closest in time to |
| | the subframe #i received from the positioning node. |
| | Multiple DL PRS resources can be used to determine the start of one subframe |
| | of the first arrival path of the positioning node. |
| | For frequency range 1, the reference point for TUE-RX measurement shall be the |
| | Rx antenna connector of the UE and the reference point for TUE-TX measurement |
| | shall be the Tx antenna connector of the UE. For frequency range 2, the |
| | reference point for TUE-RX measurement shall be the |
| | Rx antenna |
| | of the UE and |
| | the reference point for TUE-TX measurement shall be the Tx antenna of the UE. |
| Applicable | RRC_CONNECTED intra-frequency |
| for | RRC_CONNECTED inter-frequency |

The present disclosure relates to a system, apparatus and methods for enhanced carrier measurements based on the determination of the subcarrier difference phase between configured positioning reference signal time-frequency resources. Devices may measure the overall phase of a carrier with the added cost of resolving the integer ambiguity due to the short wavelengths, while on the other hand subcarrier phase measurements may be exploited with a coarse degree of accuracy. Table 5 is an exemplary illustration of the unambiguous time duration T and distance D for the different values of subcarrier (fk+Δk−fk) and carrier frequency fc, where f=ω/2π.

TABLE 5

| Frequency: | | Unambiguous | | Unambiguous | |
|---|---|---|---|---|---|
| (fk + Ak − fk) or fc | | duration: T | | distance: D | |
| (fk + Ak − fk) | = 15 kHz | 66.66 | μs | 19.90 | km |
| (fk + Ak − fx) | = 60 KHz | 16.66 | μs | 4.99 | km |
| (fk + Ak − fk) | = 240 KHz | 41.66 | μs | 1.25 | km |
| (fk + Ak − fk) | = 100 MHZ | 10 | ns | 3 | m |
| fc | = 3.5 GHZ | 28.57 | ns | 8.5 | cm |
| fc | = 60 GHz | 0.0167 | ns | 0.5 | cm |

The present disclosure described methods and devices configured to determine and configure a set of positioning reference signal resources, e g., DL-PRS such that the frequency separation between subcarriers on which the subcarrier phase difference is measured yields an accurate carrier phase estimate. Processes may depend on the prior knowledge of the unambiguous distance between the transmitter (e.g., gNB) and receiver (e.g. UE), which may be obtained via existing RAT-dependent and RAT-independent location estimation techniques.

In this disclosure, a positioning-related reference signal may be referred to as a reference signal used for positioning to estimate a target-UE's location, e.g., PRS, or based on existing reference signals such as CSI-RS or SRS, SRS for positioning, and MIMO SRS. A target-UE may be referred to as the device or entity to be localized or positioned. In various embodiments, the term ‘PRS’ may refer to any signal used for positioning such as a reference signal, which may or may not be used primarily for positioning. References made to position and location information may refer to either an absolute position, relative position with respect to another node or entity, ranging in terms of distance, ranging in terms of direction, or combinations thereof.

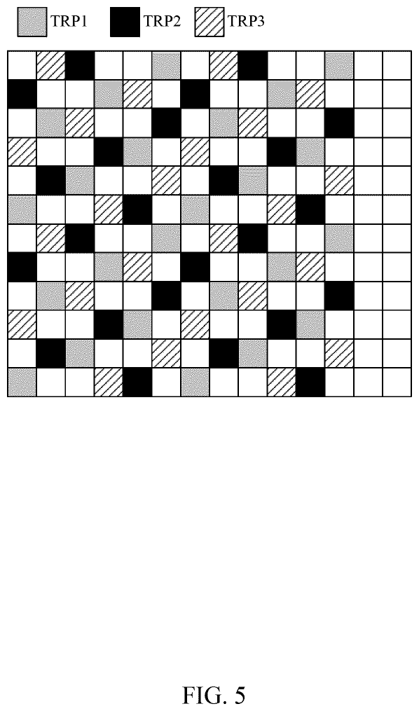

Positioning reference symbols can be used for carrier phase positioning in 3GPP, which may include downlink (DL) PRS, e.g., DL-PRS or uplink (UL) PRS, e.g., UL-SRS. An example of a DL comb-6 configuration of positioning reference symbols within a single PRB for three transmission/reception points (TRPs) is shown in FIG. 5. Using the comb-6 configuration as an example, it can be noted that for each symbol in the frequency domain, two of the twelve resource elements contain reference symbols for a given TRP. This pattern and density may vary and is dependent on the comb size structure of the PRS transmission. On the Uu interface, the currently supported DL-PRS comb sizes include comb-2, comb-4, comb-6 and comb-12.

The receiving device, such as a UE, uses these reference symbols to estimate the phase of the carrier signal. This phase information can then be used to estimate the distance from the transmitting device to the UE. The distance between transmitting device and the receiving device can be expressed in terms of radians using the following:

$$2 π \frac{d}{λ} = 2 π d \frac{f}{c} , \qquad ( 1 )$$

where c is the speed of light. Because carrier phase can only be measured modulo 2π, the phase cannot be used to uniquely determine the distance between the transmitter and the receiver if the distance is greater than or equal to one wavelength, or equivalently, if

$$d \frac{f}{c} \geq 1 \qquad ( 2 )$$

Thus, the maximum distance that can be unambiguously determined from the carrier phase is

$$d < \frac{c}{f} \qquad ( 3 )$$

If θ is the measured carrier phase and d<c/f, then the distance d can be computed as

$$d = \frac{θ}{2 π} \frac{c}{f} \qquad ( 4 )$$

A similar but alternative method for determining the distance is to consider the change in carrier phase as a function of frequency. The difference in carrier phase for frequencies f₁ and f₂ is given by

$${θ}_{1} - {θ}_{2} = 2 π ( \frac{d}{{λ}_{1}} - \frac{d}{{λ}_{2}} ) = 2 π \frac{d}{c} ( {f}_{1} - {f}_{2} ) \qquad ( 5 )$$

Again, because carrier phase can only be measured modulo 2π, it must be that

$${θ}_{1} - {θ}_{2} < 2 π , \qquad ( 6 )$$

or equivalently, that

$${f}_{1} - {f}_{2} < \frac{c}{d} \qquad ( 7 )$$

If this condition is met, then the distance can be unambiguously computed as

$$d = \frac{{θ}_{1} - {θ}_{2}}{{f}_{1} - {f}_{2}} \frac{c}{2 π} , \qquad ( 8 )$$

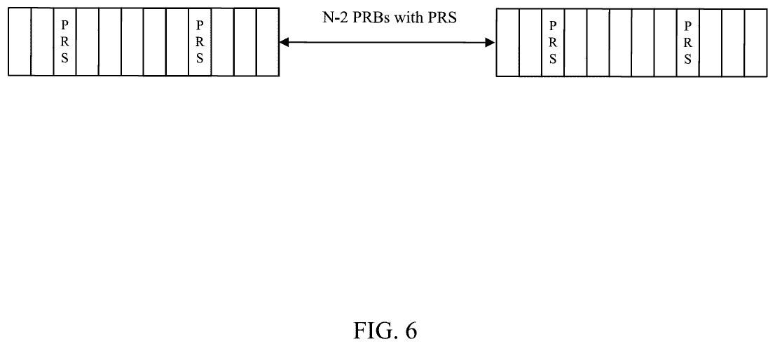

FIG. 6 illustrates an example in which positioning reference symbols are equally spaced in the frequency domain. In this example, there are N PRBs, each with a PRB having a plurality of PRS symbols. For illustration purposes, the PRS transmissions correspond to the same TRP. The indices of the PRS for this example can be expressed as the set I given by:

$$I = \{ 3 + 6 i : i ∈ 0 , 1 , … , 2 N - 1 \} \qquad ( 9 )$$

Let yᵢ denote the demodulated received PRS symbol given by:

$${y}_{i} = {h}_{i} {r}_{i} {e}^{j ( - ( {ω}_{c} + i Δω ) τ + {θ}_{T} - {θ}_{R} )} + {n}_{i} , \qquad ( 10 )$$

where hᵢ denotes the channel, rᵢ denotes the known reference symbol, ω_{c} denotes the carrier frequency (in radians), Δω denotes the subcarrier spacing, τ=d/c denotes the propagation delay corresponding to the distance d between the TRP and the UE, θ_{T} denotes the fixed phase offset of the TRP, θ_{R} denotes the fixed phase offset of the receiver, and nᵢ denotes additive noise.

Multiplying yᵢ by the conjugate

$${r}_{i}^{*}$$

of the known positioning reference symbol (assumed to have unit amplitude) yields

$${z}_{i} = {h}_{i} {e}^{j ( - ( {ω}_{c} + i Δω ) τ + {θ}_{T} - {θ}_{R} )} + {n}_{i} {r}_{i}^{*} , \qquad ( 11 )$$

The phase of θᵢ denote the phase of zᵢ which is given by

$${θ}_{i} = arg ( {z}_{i} ) = - ( {ω}_{c} + i Δω ) τ + {θ}_{T} - {θ}_{R} + {\hat{n}}_{i} , \qquad ( 12 )$$

where \hat{n}ᵢ is a zero-mean random variable with variance σ².

Any two resource elements with a PRS can be used to generate an estimate of the delay. Consider the two outermost PRS with phases given by θ₃ and θ_{9+12*(N-1)} and note that

$${θ}_{3} - {θ}_{9 + 12 * ( N - 1 )} = ( - ( {ω}_{c} + 3 Δω ) τ + {θ}_{T} - {θ}_{R} + {\hat{n}}_{3} ) - ( - ( {ω}_{c} + ( 9 + 12 * ( N - 1 ) ) Δ ω ) τ + {θ}_{T} - {θ}_{R} + {\hat{n}}_{9 + 12 * ( N - 1 )} ) = ( 6 + 12 * ( N - 1 ) ) Δ ω τ + {\hat{n}}_{3} - {\hat{n}}_{9 + 12 * ( N - 1 )} \qquad ( 13 )$$

Thus, τ can be estimated as

$$\hat{τ} = \frac{{θ}_{3} - {θ}_{9 + 12 * ( N - 1 )}}{( 6 + 12 * ( N - 1 ) ) Δ ω} = τ + \frac{{\hat{n}}_{3} - {\hat{n}}_{9 + 12 * ( N - 1 )}}{( 6 + 12 * ( N - 1 ) ) Δ ω} = τ + v \qquad ( 14 )$$

Since the random variables \hat{N}₃ and \hat{N}_{9+12*(N-1)} are independent with variance σ², the variance of the random variable v is given by

$${σ}_{v}^{2} = \frac{2 {σ}^{2}}{{( 6 + 12 * ( N - 1 ) )}^{2} {( Δ ω )}^{2}} , \qquad ( 15 )$$

and the signal-to-noise ratio of the estimate \hat{τ} is given by

$$SNR ( \hat{τ} ) = \frac{{τ}^{2}}{2 {σ}^{2}} {( 6 + 12 * ( N - 1 ) )}^{2} {( Δ ω )}^{2} , \qquad ( 16 )$$

An independent estimate (based on independent measurements) of τ can be formed using the next two outermost PRS with phase measurements θ₉ and θ_{3+12*(N-1)}. The signal-to-noise ratio of the resulting estimate f is given by

$$SNR ( \hat{τ} ) = \frac{{τ}^{2}}{2 {σ}^{2}} {( 9 + 12 * ( N - 2 ) )}^{2} {( Δ ω )}^{2} . \qquad ( 17 )$$

Moving inward in this manner, more independent estimates of r can be formed until all the PRS pairs have been used. As the innermost PRS pair is only separated by 6 resource elements, the SNR for this pair is given by

$$SNR ( \hat{τ} ) = \frac{{τ}^{2}}{2 {σ}^{2}} {6}^{2} {( Δ ω )}^{2} = \frac{{τ}^{2} 18 {( Δ ω )}^{2}}{{σ}^{2}} . \qquad ( 18 )$$

If the number of PRBs with PRS is equal to 100, the ratio of the SNRs for the estimates of τ using the outermost and innermost PRS is given by

$$\frac{\frac{{τ}^{2}}{2 {σ}^{2}} {( 6 + 12 * ( 100 - 1 ) )}^{2} {( Δ ω )}^{2}}{\frac{{τ}^{2} 18 {( Δ ω )}^{2}}{{σ}^{2}}} = \frac{119 {4}^{2}}{18} = 79 , 202 \qquad ( 19 )$$

This illustrates the point that there is little benefit in placing PRS in the PRBs near the middle of the carrier bandwidth for the purpose of carrier phase positioning. If the independent estimates of τ for the outermost L PRB pairs are optimally combined in accordance with their respective SNRs by being weighted by the frequency separation of the PRS used to form the estimate \hat{τ}, the SNR of the result \hat{τ}_{comb} will be the sum of the SNRs which is given by

$$SNR ( {\hat{τ}}_{comb} ) = \frac{{τ}^{2}}{2 {σ}^{2}} {( Δ ω )}^{2} {\sum }_{k = 1}^{L} {( 6 + 12 * ( N - k ) )}^{2} \qquad ( 20 )$$

If all N pairs of PRB's are used to estimate τ, the result is given by

$$SNR ( {\hat{τ}}_{comb} ) = \frac{{τ}^{2}}{2 {σ}^{2}} {( Δ ω )}^{2} {\sum }_{k = 1}^{N} {( 6 + 12 * ( N - k ) )}^{2} = \frac{{τ}^{2}}{{σ}^{2}} {( Δ ω )}^{2} ( 24 {N}^{3} - 6 N ) , \qquad ( 21 )$$

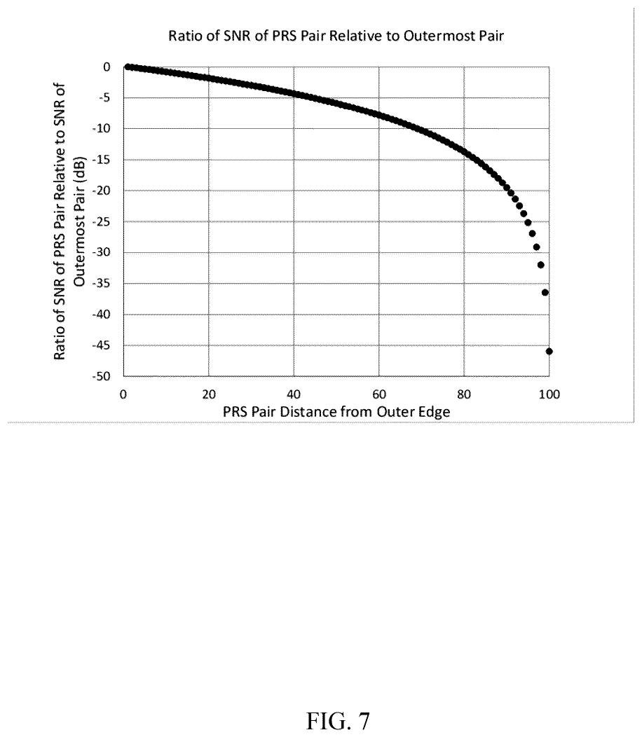

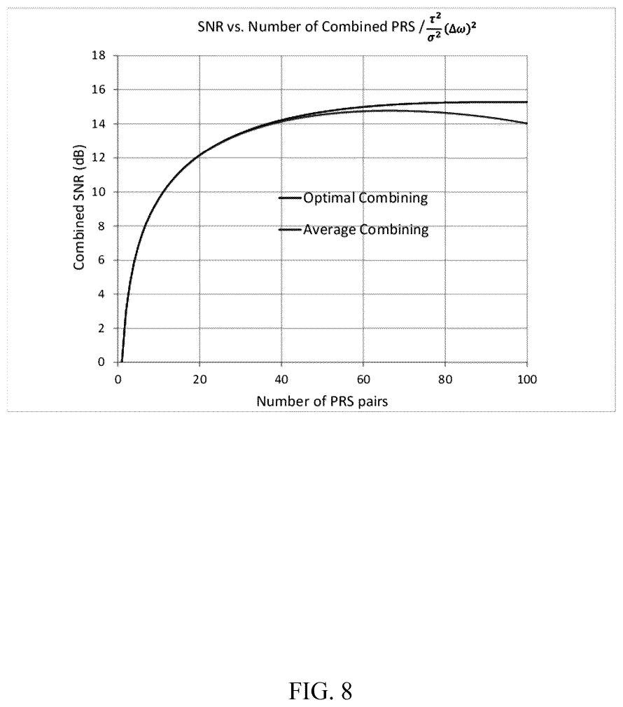

so that SNR increases with the cube of the number of PRBs N³. The SNR for each of the PRS pairs is shown in FIG. 7 for the case of 100 PRBs. The cumulative SNR is shown in FIG. 8 as the number of PRS pairs is increased from 1 to N, starting from the outermost pair and moving to the innermost pair. It can be observed from FIG. 8 that there is little benefit with respect to the SNR of the estimate of f resulting from the PRS in the inner N/2 PRBs. As a result, it should be possible to use these PRBs for data.

The above result can be generalized if it is assumed that the number of PRS RE's per PRB evenly divides 12, so that the number of PRS per PRB is 1, 2, 3, 4, 6, or 12. In the case in which there are m PRS per PRB, the frequency separation between the k-th outermost PRS pair is given by:

$$( 12 N - ( 2 k - 1 ) \frac{I 2}{m} ) Δω , \qquad ( 22 )$$

so that the sum SNR for the L outermost PRS pairs is given by:

$$SNR ( {\hat{τ}}_{comb} ) = \frac{{τ}^{2}}{2 {σ}^{2}} {( Δ ω )}^{2} {\sum }_{k = 1}^{L} {( 12 N - ( 2 k - 1 ) \frac{I 2}{m} )}^{2} , \qquad ( 23 )$$

and the SNR for all mN/2 PRS pairs is given by:

$$SNR ( {\hat{τ}}_{comb} ) = \frac{{τ}^{2}}{2 {σ}^{2}} {( Δω )}^{2} {\sum }_{k = 1}^{\frac{mN}{2}} {( 12 N - ( 2 k - 1 ) \frac{12}{m} )}^{2} == \frac{{τ}^{2}}{{σ}^{2}} {( Δ ω )}^{2} 12 ( {N}^{3} m - \frac{N}{m} ) . \qquad ( 24 )$$

Another approach to estimating r is to first average the phase measurements for a number of PRS symbols at the bottom of the carrier and assign this average phase to the average frequency of the PRS symbols used to form the average. In a similar manner, phase measurements for a number of PRS symbols at the top of the carrier are averaged and the average phase is again assigned to the average frequency of the PRS symbols used to form the average. These two average measurements are then used to estimate the delay.

Define \hat{θ}_{low,L} as the average phase measurement computed using the L lowest frequency PRS so that

$${\hat{θ}}_{low , L} = \frac{1}{L} {\sum }_{k = 0}^{L - 1} {θ}_{3 + 6 k} = \frac{1}{L} {\sum }_{k = 0}^{L - 1} - ( {ω}_{c} + ( 3 + 6 k ) Δ ω ) τ + {θ}_{T} - {θ}_{R} + {\hat{n}}_{3 + 6 k} = {θ}_{T} - {θ}_{R} + \frac{1}{L} {\sum }_{k = 0}^{L - 1} - ( {ω}_{c} + ( 3 + 6 k ) Δ ω ) τ + \frac{1}{L} {\sum }_{k = 0}^{L - 1} {\hat{n}}_{3 + 6 k} = {θ}_{T} - {θ}_{R} - ( {ω}_{c} + 3 L Δω ) τ + \frac{1}{L} {\sum }_{k = 0}^{L - 1} {\hat{n}}_{3 + 6 k} = {θ}_{T} - {θ}_{R} - ( {ω}_{c} + 3 L Δω ) τ + {\hat{n}}_{low , L} , \qquad ( 25 )$$

Here, averaging is performed for one symbol within a PRB. However, averaging can be performed in other ways. In an embodiment, averaging is performed across all positioning reference symbols within a RB. In Comb 6, there are 2 PRS per symbol, and 12 symbols per RB. In that case, averaging could be performed for 24 measurements for a given PRB.

It can be observed that the random variable \hat{n}_{low,L} has a variance of σ²/L and that the frequency ω_{c}+3 L Δω corresponds to the frequency of resource element 3 L. Similarly, we define \hat{θ}_{high,L} as the average phase measurement computed using the L highest frequency PRS, so that

$${\hat{θ}}_{high , L} = \frac{1}{L} {\sum }_{k = 0}^{L - 1} {θ}_{9 + 12 ( N - 1 ) - 6 k} = \frac{1}{L} {\sum }_{k = 0}^{L - 1} - ( {ω}_{c} + ( 9 + 12 ( N - 1 ) - 6 k ) Δ ω ) τ + {θ}_{T} - {θ}_{R} + {\hat{n}}_{9 + 12 ( N - 1 ) - 6 k} = {θ}_{T} - {θ}_{R} - ( {ω}_{c} + ( 12 N - 3 L ) Δ ω ) τ + \frac{1}{L} {\sum }_{k = 0}^{L - 1} {\hat{n}}_{9 + 12 ( N - 1 ) - 6 k} = {θ}_{T} - {θ}_{R} - ( {ω}_{c} + ( 12 N - 3 L ) Δ ω ) τ + \frac{1}{L} {\sum }_{k = 0}^{L - I} {\hat{n}}_{9 + 12 ( N - 1 ) - 6 k} = {θ}_{T} - {θ}_{R} - ( {ω}_{c} + ( 12 N - 3 L ) Δ ω ) τ + {\hat{n}}_{high , L} . \qquad ( 26 )$$

It can be observed that the random variable \hat{n}_{high,L} also has a variance of σ²/L and that the frequency ω_{c}+(12N−3L) Δω corresponds to the frequency of resource element 12N−3L. With the averages of the phase measurements \hat{θ}_{low,L} and \hat{θ}_{high,L} note that

$${\hat{θ}}_{low , L} - {\hat{θ}}_{high , L} = ( - 3 L + ( 12 N - 3 L ) ) Δωτ + {\hat{n}}_{low , L} - {\hat{n}}_{high , L} = ( 12 N - 6 L ) Δ ω τ + {\hat{n}}_{low , L} - {\hat{n}}_{high , L} . \qquad ( 27 )$$

Thus, the delay τ can be estimated as

$$\hat{τ} = \frac{{\hat{θ}}_{low , L} - {\hat{θ}}_{high , L}}{( 12 N - 6 L ) Δ ω} = τ + \frac{{\hat{n}}_{low , L} - {\hat{n}}_{high , L}}{( 2 N - L ) 6 Δ ω}$$

for which the signal-to-noise ratio is given by

$$SNR ( \hat{τ} ) = \frac{{τ}^{2}}{2 {σ}^{2} / L} {( Δω )}^{2} {( 12 N - 6 L )}^{2} = \frac{{τ}^{2}}{{σ}^{2}} 18 {( Δω )}^{2} {L ( 2 N - L )}^{2} . \qquad ( 28 )$$

Interestingly, it can be observed that increasing the number of PRS averaged does not always increase the SNR of the estimate \hat{τ}. In particular, the SNR is maximized when

$$\frac{d}{dl} ( {L ( 2 N - L )}^{2} ) = 0 , \qquad ( 29 )$$

for which the only feasible solution is

$$L = ( \frac{2}{3} ) N .$$

Thus, when this averaging method is used, the PRS in the middle N/3 RBs are of no value when estimating τ. It should be noted that the fraction of RB's that should not be used is independent of the number of RB's N. For the case that L=2N/3, the signal-to-noise ratio of f is given by

$$SNR ( \hat{τ} ) = \frac{{τ}^{2}}{{σ}^{2}} 18 {( Δ ω )}^{2} \frac{2}{3} {N ( \frac{4}{3} N )}^{2} = \frac{{τ}^{2}}{{σ}^{2}} {( Δ ω )}^{2} \frac{64}{3} {N}^{3} . \qquad ( 30 )$$

A comparison of the performance of the optimum combining with the averaging method is shown in FIG. 8 as a function of the number of PRS resource elements (Res) that are used in the case that the number of PRB's is 100. For this example, there are two PRS per PRB, and thus the number of PRS pairs is equal to the number RBs. From FIG. 8, it can be observed that the SNR is slightly worse than for optimal combining and that SNR degrades as the number of PRS pairs used in the average exceeds 2N/3. As a result, there is no benefit from the N/3 PRS pairs located in the inner N/3 PRBs.

The result for the averaging method can be generalized if it is assumed that the number of PRS REs per PRB evenly divides 12, so that the number of PRS per PRB is 1, 2, 3, 4, 6, or 12. With this assumption, the signal-to-noise ratio for the averaging method can be expressed as

$$SNR ( \hat{τ} ) = \frac{{τ}^{2}}{2 {σ}^{2} / L} {( Δ ω )}^{2} {( 12 N - ( \frac{12}{m} ) L )}^{2} = \frac{{τ}^{2}}{{σ}^{2}} {( Δ ω )}^{2} 72 {L ( N - \frac{L}{m} )}^{2} \qquad ( 31 )$$

where m denotes the number of PRS per PRB. The maximum signal-to-noise ratio is achieved when

$$\frac{d}{dl} ( {L ( N - \frac{L}{m} )}^{2} ) = 0 \qquad ( 32 )$$

for which the only feasible solution is L=mN/3. With m PRS per PRB, there are a total of mN/2 PRS pairs in the N PRBs. The outer mN/3 PRS pairs occupy the outer N/3 PRBs at each edge of the carrier. Thus, the result that the inner N/3 PRBs are of no benefit is independent of the number of PRSs per PRB.

When L=mN/3, the signal-to-noise ratio is given by

$$SNR ( \hat{τ} ) = \frac{{τ}^{2}}{{σ}^{2}} {( Δω )}^{2} 72 \frac{mN}{3} {( N - \frac{mN / 3}{m} )}^{2} = \frac{{τ}^{2}}{{σ}^{2}} {( Δω )}^{2} \frac{32}{3} {mN}^{3} . \qquad ( 33 )$$

According to an embodiment, a network entity, e.g., a location server, may allow PRBs to be configured non-contiguously within the carrier bandwidth. This is applicable to PRS and Data PRBs which may be multiplexed across a configured bandwidth. The location server allows PRBs not configured for PRS to be used for data. Configuration details are further described below.

The maximum size of the gaps between PRS PRBs may be based on the maximum delay over a set of TRPs to track phase wrapping. If d is the maximum delay, then the phase changes by 2π over c/d Hz. In order to track phase wrapping, the carrier phase may be measured at least every c/2d Hz.

Averaging of phase estimates across frequency can be used to better estimate the phase and to track phase wrapping. As noted in the description of the phase estimate averaging above, multiple PRS phase measurements can be averaged to improve the signal-to-noise ratio of the phase estimate. The mean of this averaged phase corresponds to the mean phase of the frequency equal to the average of the frequencies of the PRS phase measurements that are averaged.

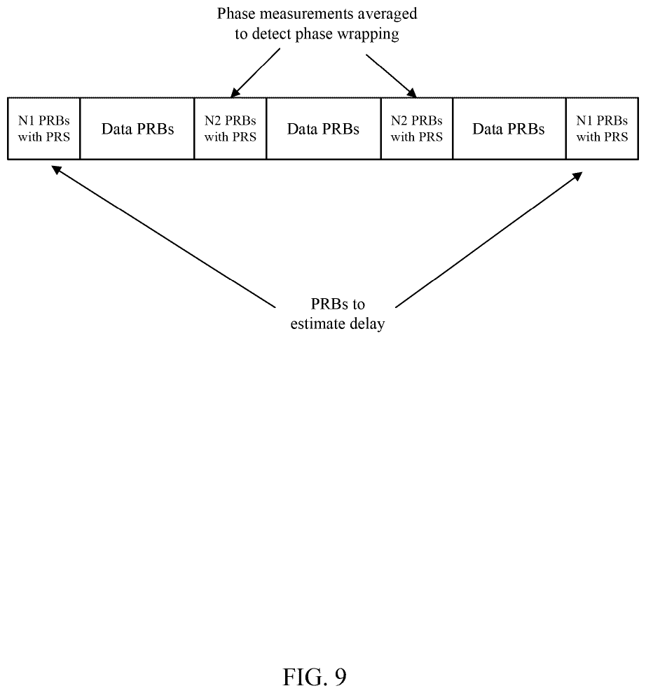

In view of the above discussion, the following features may be present in embodiments:
Two blocks of PRBs with PRSs are placed as far apart as possible in the frequency domain.
The number of PRBs with PRS at each edge can be determined as a function of the desired signal-to-noise ratio of the estimate of τ\hat{ }, the distance between the two blocks of PRBs, and the number of PRS per PRB. This characteristic can be exploited to improve spectral efficiency by scheduling more data PRBs and less PRS PRBs when bandwidth is available.
The RBs in the middle portion may be used for data with the exception of periodically spaced blocks of PRBs with PRS that are used to estimate the carrier phase and to determine if phase wrapping has occurred (this can be detected using the fact that the carrier phase always decreases with frequency until the phase jumps by 2π when the phase wraps). The concept is illustrated in FIG. 9, which shows a set of innermost PRBs N2 used to detect phase wrapping and a set of outermost PRBs N1 used to estimate delay.
The number of PRS PRBs N1 used to estimate delay and the number of PRS PRBs N2 (See FIG. 9) used to estimate phase and detect phase wrapping can be different. The number N1 may depend on the total number of RBs N spanning the lowest frequency PRBs with PRS to the highest frequency PRBs with PRS, e.g. the total bandwidth bracketed by PRS PRBs N2. Phase wrapping can occur multiple times across larger bandwidths, so larger bandwidths may have a larger number of N1 PRBs to detect each interval of phase wrapping. The N1 PRBs may be divided into multiple sets, each of which is separated by data PRBs.

The number of PRBs with PRS needed to achieve a given signal-to-noise ratio for the delay estimate \hat{τ} depends on the separation of the PRBs. For the averaging method, the signal-to-noise ratio is given by

$$SNR ( \hat{τ} ) = \frac{{τ}^{2}}{{σ}^{2}} {( Δω )}^{2} 72 {L ( N - \frac{L}{m} )}^{2}$$

where N is the number of RB's, m is the number of PRS per PRB, and L is the number of PRS pairs combined. As N is increased, the number of PRS pairs needed to achieve a given signal to noise ratio is decreased, and as a result, fewer of the PRBs may be used to carry PRSs.

Consider a first case in which the number of PRBs is N₁ and the number of combined PRS pairs is L₁. The corresponding signal-to-noise ratio is given by

$$SNR ( \hat{τ} ) = \frac{{τ}^{2}}{{σ}^{2}} {( Δω )}^{2} 72 {{L}_{1} ( N - \frac{{L}_{1}}{m} )}^{2}$$

Now consider the case that the number of PRB's is N₂ and consider the number of PRS pairs L₂ required to achieve the same signal to noise ratio. We have

$$\frac{{τ}^{2}}{{σ}^{2}} {( Δω )}^{2} 72 {{L}_{2} ( {N}_{2} - \frac{{L}_{2}}{m} )}^{2} = \frac{{τ}^{2}}{{σ}^{2}} {( Δω )}^{2} 72 {{L}_{1} ( {N}_{1} - \frac{{L}_{1}}{m} )}^{2}$$

or equivalently

$${{L}_{2} ( {N}_{2} - \frac{{L}_{2}}{m} )}^{2} = {{L}_{1} ( {N}_{1} - \frac{{L}_{1}}{m} )}^{2} .$$

Consider an example in which N₁=50, L₁=20, and m=2. If the number of PRB's is increased to N₂=100, then the number of PRS pairs L₂ needed to achieve the same signal-to-noise ratio can be determined using

$${{L}_{2} ( 100 - \frac{{L}_{2}}{2} )}^{2} \geq 20 {( 50 - \frac{20}{2} )}^{2} = 3200.$$

It can be noted that this inequality is satisfied for L₂≥4, so that when the number of RBs is increased from 50 to 100, the number of PRS pairs can be decreased from 20 to 4 while still achieving the same signal-to-noise ratio. Since the number of PRS pairs is reduced, the number of PRBs which can be used for data transmission is increased.

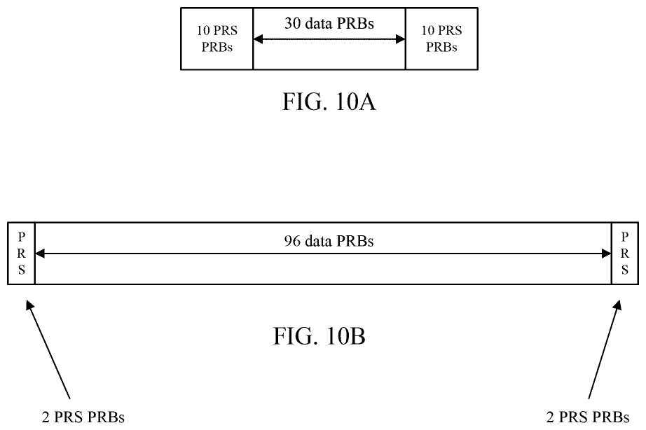

The phenomenon is illustrated in FIGS. 10A and 10B. In FIG. 10A, the contiguous bandwidth spans 50 PRBs, while in FIG. 10B, the contiguous bandwidth spans 100 PRBs. The same SNR is achieved by outermost sets of 2 PRBs for the 100 PRBs of FIG. 10B as the SNR achieved using measurements of 10 PRS PRBs as outermost sets for a bandwidth of 50 PRBS.

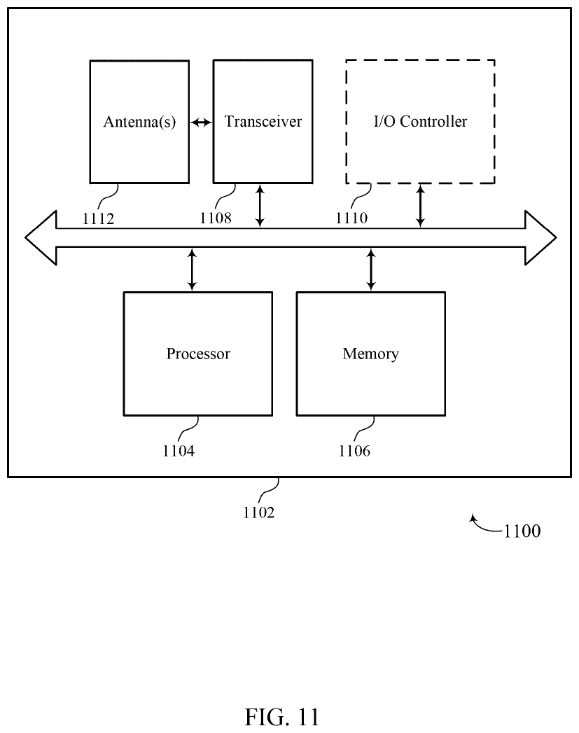

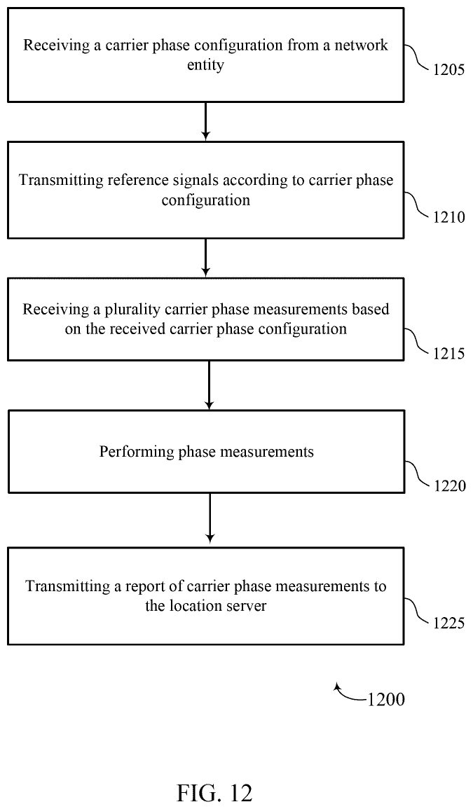

FIG. 11 illustrates an example of a block diagram 1100 of a device 1102 that supports configuring and processing reference signals for carrier phase measurements in accordance with aspects of the present disclosure. The device 1102 may be an example of a network entity 102 or a UE 104 as described herein. The device 1102 may support wireless communication with one or more network entities 102, UEs 104, or any combination thereof. The device 1102 may include components for bi-directional communications including components for transmitting and receiving communications, such as a processor 1104, a memory 1106, a transceiver 1108, and an I/O controller 1110. These components may be in electronic communication or otherwise coupled (e.g., operatively, communicatively, functionally, electronically, electrically) via one or more interfaces (e.g., buses).

The processor 1104, the memory 1106, the transceiver 1108, or various combinations thereof or various components thereof may be examples of means for performing various aspects of the present disclosure as described herein. For example, the processor 1104, the memory 1106, the transceiver 1108, or various combinations or components thereof may support a method for performing one or more of the operations described herein.

In some implementations, the processor 1104, the memory 1106, the transceiver 1108, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 1104 and the memory 1106 coupled with the processor 1104 may be configured to perform one or more of the functions described herein (e.g., executing, by the processor 1104, instructions stored in the memory 1106).

For example, the processor 1104 may support wireless communication at the device 1102 in accordance with examples as disclosed herein. Processor 1104 may be configured as or otherwise support a means for configuring and processing reference signals for carrier phase measurements.

The processor 1104 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 1104 may be configured to operate a memory array using a memory controller. In some other implementations, a memory controller may be integrated into the processor 1104. The processor 1104 may be configured to execute computer-readable instructions stored in a memory (e.g., the memory 1106) to cause the device 1102 to perform various functions of the present disclosure.

The memory 1106 may include random access memory (RAM) and read-only memory (ROM). The memory 1106 may store computer-readable, computer-executable code including instructions that, when executed by the processor 1104 cause the device 1102 to perform various functions described herein. The code may be stored in a non-transitory computer-readable medium such as system memory or another type of memory. In some implementations, the code may not be directly executable by the processor 1104 but may cause a computer (e.g., when compiled and executed) to perform functions described herein. In some implementations, the memory 1106 may include, among other things, a basic I/O system (BIOS) which may control basic hardware or software operation such as the interaction with peripheral components or devices.

The I/O controller 1110 may manage input and output signals for the device 1102. The I/O controller 1110 may also manage peripherals not integrated into the device M02. In some implementations, the I/O controller 1110 may represent a physical connection or port to an external peripheral. In some implementations, the I/O controller 1110 may utilize an operating system such as iOS®, ANDROID®, MS-DOS®, MS-WINDOWS®, OS/2®, UNIX®, LINUX®, or another known operating system. In some implementations, the I/O controller 1110 may be implemented as part of a processor, such as the processor 1104. In some implementations, a user may interact with the device 1102 via the I/O controller 1110 or via hardware components controlled by the I/O controller 1110.

In some implementations, the device 1102 may include a single antenna 1112. However, in some other implementations, the device 1102 may have more than one antenna 1112 (i.e., multiple antennas), including multiple antenna panels or antenna arrays, which may be capable of concurrently transmitting or receiving multiple wireless transmissions. The transceiver 1108 may communicate bi-directionally, via the one or more antennas 1112, wired, or wireless links as described herein. For example, the transceiver 1108 may represent a wireless transceiver and may communicate bi-directionally with another wireless transceiver. The transceiver 1108 may also include a modem to modulate the packets, to provide the modulated packets to one or more antennas 1112 for transmission, and to demodulate packets received from the one or more antennas 1112.

FIG. 1200 illustrates a flowchart of a method 1200 that supports configuring and processing reference signals for carrier phase measurements in accordance with aspects of the present disclosure. The operations of method 1200 may be implemented by a device or its components as described herein. For example, the operations of method 1200 may be performed by a network entity 102, e.g. a gNB, as described with reference to FIGS. 1 and 11. In some implementations, the device may execute a set of instructions to control the function elements of the device to perform the described functions. Additionally, or alternatively, the device may perform aspects of the described functions using special-purpose hardware.

In an embodiment, method 1200 enables a plurality of UEs 104 to be configured with a plurality of subcarrier phase configurations in order to process the phase difference between two selected subcarrier pairs for a given a set of PRS resources. The PRS resources over which to identify and perform pair selection to perform the carrier phase difference may comprise one or more of the following PRS parameters: Positioning frequency layer (PFL), e.g., PFL ID, TRP parameters, e.g., TRP ID, Resource Sets, e.g., Resource Set ID, Resources, e.g., Resource ID.

At 1205, the method may include receiving a carrier phase configuration from a network entity 102, e.g. a location server. The operations of 1200 may be performed in accordance with examples as described herein. In some implementations, aspects of the operations of 1200 may be performed by a device as described with reference to FIG. 1.

According to one aspect of this embodiment, the location server may signal a PRS configuration indicating a pair of PRS PRBs to a target device on which to perform the sub-carrier phase difference measurements. A pair of PRS of PRBs may be signaled as an explicit indication of the X outermost pairs and/or Y innermost pairs to perform the carrier phase difference measurement. In an alternative implementation, the outermost or innermost PRS PRB pairs may be implicitly indicated based on the total number of configured PRS and/or Data PRBs for a particular UE configuration. For example, the LPP ProvideAssistanceData message may be used to signal such a configuration to the UE 104.

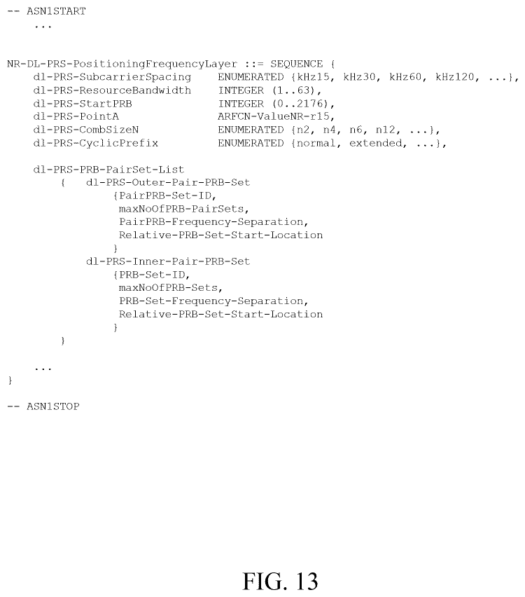

In one implementation, PRS PRB pairwise configuration may be signaled within a Positioning Frequency Layer information message. An embodiment of parameters that are indicated using existing LPP signaling is illustrated in FIG. 13. The following description is provided for an example of the content of some of the variables in the LPP signaling of FIG. 13 according to an embodiment.

nr-DL-PRS-ReferenceInfo: This field specifies the IDs of the assistance data reference TRP.

dl-PRS-SubcarrierSpacing: This field specifies the subcarrier spacing of the DL-PRS Resource, e.g. 15, 30, 60 kHz for FR1; 60, 120 kHz for FR2. All DL-PRS Resources and DL-PRS Resource Sets in the same Positioning Frequency layer may have the same value of DL-PRS-SubcarrierSpacing.

dl-PRS-ResourceBandwidth: This field specifies the number of PRBs allocated for the DL-PRS Resource (allocated DL-PRS bandwidth) in multiples of 4 PRBs. All DL-PRS Resources of the DL-PRS Resource Set have the same bandwidth. All DL-PRS Resource Sets belonging to the same Positioning Frequency Layer have the same value of DL-PRS Bandwidth and Start PRB.Integer value 1 corresponds to 24 PRBs, value 2 corresponds to 28 PRBs, value 3 corresponds to 32 PRBs and so on up to value 63 which corresponds to 280 PRBs.

dl-PRS-StartPRB: This field specifies the start PRB index defined as offset with respect to reference DL-PRS Point A for the Positioning Frequency Layer. All DL-PRS Resources Sets belonging to the same Positioning Frequency Layer have the same value of dl-PRS-StartPRB.

dl-PRS-PointA: This field specifies the absolute frequency of the reference resource block for the DL-PRS. Its lowest subcarrier is also known as DL-PRS Point A. A single DL-PRS Point A for DL-PRS Resource allocation is provided per Positioning Frequency Layer. All DL-PRS Resources belonging to the same DL-PRS Resource Set may have the same DL-PRS Point A.

dl-PRS-CombSizeN: This field specifies the Resource Element spacing in each symbol of the DL-PRS Resource. All DL-PRS Resource Sets belonging to the same Positioning Frequency Layer may have the same value of comb size N.

dl-PRS-CyclicPrefix: This field specifies the Cyclic Prefix length of the DL-PRS Resource. All DL-PRS Resource Sets belonging to the same Positioning Frequency Layer may have the same value of dl-PRS-CyclicPrefix.

dl-PRS-PRB-PairSet-List: This field defines the set of PRS PRB pairs for which the subcarrier phases are measured and the corresponding phase difference and delay for each PRS PRB Pair are computed. This field may comprise of a plurality of PRS PRB pairs. The pairs may include two contiguous or non-contiguous set of PRS PRBs. The delays may be a function of the distance between the transmitter, e.g., gNB 102 and receiver, e.g., UE 104. In other implementations, this delay may also be referred to as the propagation delay of the radio channel environment between transmitter and receiver.

dl-PRS-Outer-Pair-PRB-Set: This field defines the set of outer PRS PRB pairs for which the subcarrier phase differences and delay for each PRB Pair are computed. This field may comprise of a plurality of outer PRB pairs.

PairPRB-Set-ID: This field defines the set of outer PRB pairs for which the subcarrier phases and delays for each PRB Pair are computed. This field may comprise of a plurality of outer PRB pairs.

maxNoOfPairPRB-Sets: This field defines the max set of PRS pair PRBs, which may be subject to UE capability. In one implementation, the network, e.g., LMF may signal this field to the target UE. In an alternative implementation, a prior LPP procedure such as the LPP Capability exchange procedure including Request and Provide Capabilities may be signaled to the network from the UE, to indicate maximum number of PRB sets that may supported by the target UE. For example, a reduced capability UE may have a lower maximum number of PRS Pair PRBs than a normal UE capable of supporting higher bandwidth, e.g., 100 MHz.

PairPRB-Set-Frequency-Separation: This field defines the frequency separation or equivalent between a pair of PRS PRBs used to determine the subcarrier phases and corresponding delay. In particular, this field may define the frequency separation between a set of outermost PRS PRB pairs. Alternatively, this field may define the frequency separation between the innermost PRS PRB pairs, or any other set of PRB pairs.

dl-PRS-Inner-Pair-PRB-Set: This field defines a set of inner PRS PRB pairs for which the subcarrier phase difference and delay for each PRS PRB Pair are computed. This field may comprise of a plurality of inner PRS PRB pairs, and may comprise inner PRB pairs that are separated in the frequency domain by data PRBs.

Relative-PRB-Set-Start-Location: This field defines the location of one or more pairs of PRS PRBs relative to the start PRB. In one implementation, this may be defined in terms of the relative PRB location of the first PRB within the Pair PRB set to the start PRB. In another implementation, this parameter may be defined in terms of the relative PRB location of the second PRB within the Pair PRB set to the start PRB.

In an embodiment, the above defined configuration parameters for PRS PRB pairs in FIG. 13 may also be implicitly configured as a function of the dl-PRS-Start-PRB and dl-PRS-PointA Information Elements (IEs) for the first and second set of PRS PRBs.

According to an aspect of the embodiment, the defined configuration parameters for PRS PRB pairs in FIG. 13 may be configured for an active DL BWP in the case of DL-PRS or an active UL BWP for SRS for positioning. In the case of an active DL BWP, data PRBs and PRS PRBs may be multiplexed across time and frequency, where both the data and PRS PRBs are configured in a non-contiguous manner. In particular, blocks of PRS PRBs may be separated by blocks of data PRBs.

In one implementation, the above defined configuration parameters for PRS PRB pairs in FIG. 13 may be signalled in one or more of the following PRS resource hierarchies including: Positioning frequency layer (PFL), TRP, PRS Resource Set, PRS Resources.

In another implementation, the configuration parameters in FIG. 13 may also be applicable for the measurement SRS PRB pairs for UL-based carrier phase measurements at the NG-RAN node side, e.g., gNB 102. In this case, the NR Positioning Protocol Annex (NRPPa) TRP information exchange procedure may be used to realize this configuration based on a solicited request from the LMF.

In an embodiment, the configured number of PRS PRBs used to measure phase and delay may be derived on PRS resources which are periodically transmitted with a configured periodicity. In another embodiment, the configured number of PRS PRBs used to estimate phase and delay may be derived based on PRS resources, e.g., PRBs which are transmitted in the form of repetitions, e.g., PRS resources that are repeated based on a particular configuration, e.g., a configured repetition factor.

In an embodiment, a set of PRBs may be configured as a group of outermost or innermost pair of PRS PRBs. Such a group may be characterised by an ID, in order to identify the pair of PRBs for which to perform the carrier phase difference measurement. Such a grouping mechanism may increase signalling efficiency to avoid signalling individual pairs of PRBs, which can be extensive depending on the configured PRS resource bandwidth.

According to another aspect, in the case of UE-based positioning, a target-UE 104 may request a PRS configuration comprising a pair of PRS PRBs on which to perform the sub-carrier phase difference measurements. This request may be a recommendation of requested PRS, and the network comprising the location server and/or NG-RAN node may or may not decide to fulfil the request.

According to one aspect of this embodiment, the location server may initiate an on-demand PRS configuration procedure in order to update the pair of PRS PRBs on which to perform a sub-carrier phase difference measurement. This may be triggered on top of an existing PRS configuration.

In another implementation, the location server may signal a recommended SRS configuration indicating a pair of SRS PRBs to a target NG-RAN node, e.g., serving gNB, on which to perform the UL sub-carrier phase difference measurements. Similar to the DL PRS configuration, a pair of SRSs of PRBs may include an explicit indication of the X outermost pairs and/or Y innermost pairs to perform the carrier phase difference measurement.

In another embodiment, the outermost or innermost SRS PRB pairs may be implicitly indicated based on the total number of configured PRS and/or Data PRBs for a particular UE configuration. For example, the NRPPa Position Information Request message may be used to request such a subcarrier measurement configuration to a plurality of NG-RAN nodes.

The corresponding NRPPa Position Information Response message may be used to convey the pair of SRS resource on which to perform the subcarrier phase difference measurements. An exemplary NRPPa Positioning Information update message may be signalled from NG-RAN node to the location server in order to update a pair of SRS resources used to perform the subcarrier phase measurement. The location server may then consider the updated SRS configuration over a previous SRS configuration.

At 1210, the method may include transmitting PRS PRBs according to phase carrier configuration. The operations of 1210 may be performed in accordance with examples as described herein. In some implementations, aspects of the operations of 1210 may be performed by a device as described with reference to FIG. 1.

The PRS PRBs may be transmitted by a network entity 104 to one or more receiver 102 according to the configuration described above with respect to FIG. 11. The PRS PRBs may include innermost and outermost PRS PRB pairs, and the PRBs may be transmitted in a non-contiguous manner along with data PRBs between PRS PRBs in the frequency domain.

At 1215, the method may include receiving a plurality of carrier phase measurements based on the received carrier phase configuration. The operations of 1215 may be performed in accordance with examples as described herein. In some implementations, aspects of the operations of 1215 may be performed by a device as described with reference to FIG. 1. The carrier phase measurements may be received from a UE 102 according to the configuration discussed above with respect to FIG. 13. Receiving carrier phase measurements at 1215 may be performed when PRS PRBs are transmitted in DL.

At 1220, the method may include performing phase measurements. The operations of 1220 may be performed in accordance with examples as described herein. In some implementations, aspects of the operations of 1220 may be performed by a device as described with reference to FIG. 1. The operations of 1220 may be performed as an alternative to 1215 when PRS PRBs are transmitted in UL.

UL SRS subcarrier phase difference measurements may be performed at 1220. The subcarrier phase difference measurement may be defined as \hat{θ}_{low,L}−\hat{θ}_{high,L}, where \hat{θ}_{low,L} is the average subcarrier phase measurement computed using the L lowest frequency SRS and \hat{θ}_{high,P} the average subcarrier phase measurement computed using the P highest frequency SRS.

Multiple UL SRS resources can be used to determine the average of one subcarrier phase measurement corresponding to the L lowest frequency PRBs or corresponding to the P highest frequency PRBs from a TP. In one implementation L=P, while in other implementations L≠P, depending on the configuration.

In an alternative implementation the Lᵢ lowest frequency PRBs and Pᵢ highest frequency PRBs may originate for TPᵢ, while the Lⱼ lowest frequency PRBs and Pᵢ highest frequency PRBs may originate from TPⱼ. This is applicable based on fulfilling certain conditions such as the same PRS carrier configuration from both TPᵢ and TPⱼ.

UL SRS subcarrier delay measurements may be performed at 1220. The subcarrier delay measurement may be defined as:

$$\frac{{\hat{θ}}_{low , L} - {\hat{θ}}_{high , P}}{12 N - ( \frac{12}{m} ) L} ,$$

where \hat{θ}_{low,L} is the average subcarrier phase measurement computed using the L lowest frequency SRS and \hat{θ}_{high,P} the average subcarrier phase measurement computed using the P highest frequency SRS, N is the total number of configured SRS PRBs, m is the number of SRS per PRB and Δω denotes the configured subcarrier spacing.

Multiple UL SRS resources can be used to determine the average of one subcarrier phase measurement corresponding to the L lowest frequency PRBs or corresponding to the P highest frequency PRBs from a TP. In one implementation L=P, while in other implementations L≠P, depending on the configuration.

In an alternative implementation the Lᵢ lowest frequency PRBs and Pᵢ highest frequency PRBs may originate for TPᵢ, while the Lᵢ lowest frequency PRBs and Pᵢ highest frequency PRBs may originate from TPⱼ. This is applicable based on fulfilling certain conditions such as the same PRS carrier configuration from both TPᵢ and TPⱼ.

The measurements of 1220 are applicable for RRC_CONNECTED, RRC_INACTIVE and RRC_IDLE modes.

At 1225, the method may include transmitting a report of the received carrier phase measurements to the location server. The operations of 1225 may be performed in accordance with examples as described herein. In some implementations, aspects of the operations of 1225 may be performed by a device as described with reference to FIG. 1. The measurements transmitted at 1225 may include any measurements performed by a UE 102 or network entity (e.g. gNB) 104.

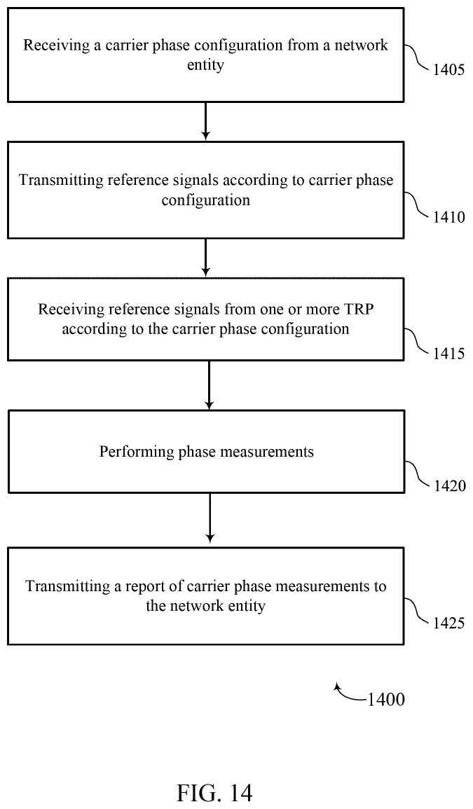

FIG. 14 illustrates a flowchart of a method 1400 that supports configuring and processing reference signals for carrier phase measurements in accordance with aspects of the present disclosure. The operations of the method 1400 may be implemented by a device or its components as described herein. For example, the operations of the method 1400 may be performed by a UE 104 as described with reference to FIGS. 1 and 11. In some implementations, the device may execute a set of instructions to control the function elements of the device to perform the described functions. Additionally, or alternatively, the device may perform aspects of the described functions using special-purpose hardware.

At 1405, the method may include receiving a carrier phase configuration from a network entity, e.g. a gNB. The operations of 1405 may be performed in accordance with examples as described herein. In some implementations, aspects of the operations of 1405 may be performed by a device as described with reference to FIG. 1.

At 1410, the method may include transmitting non-contiguous reference signals according to the received carrier phase configuration. The operations of 1410 may be performed in accordance with examples as described herein. In some implementations, aspects of the operations of 1410 may be performed by a device as described with reference to FIG. 1. The reference signals transmitted at 1410 may be SRSs.

At 1415, the method may include receiving non-contiguous reference signals from one or more TRP according to the carrier phase configuration. The operations of 1415 may be performed in accordance with examples as described herein. In some implementations, aspects of the operations of 1415 may be performed by a device as described with reference to FIG. 1.

At 1420, the method may include performing phase measurements of reference signals received at 1415. The operations of 1420 may be performed in accordance with examples as described herein. In some implementations, aspects of the operations of 1420 may be performed by a device as described with reference to FIG. 1.

In an embodiment, DL subcarrier phase difference measurements may be defined as \hat{θ}_{low,L}−\hat{θ}^{high,L}, where \hat{θ}_{low,L} is the average subcarrier phase measurement computed using the L lowest frequency PRS and \hat{θ}_{high,P} is the average subcarrier phase measurement computed using the P highest frequency PRS.

Multiple DL PRS resources can be used to determine the average of one subcarrier phase measurement corresponding to the L lowest frequency PRBs or corresponding to the P highest frequency PRBs from a TP. In one implementation L=P, while in other implementations L≠P, depending on the configuration.

In an alternative implementation the Lᵢ lowest frequency PRBs and Pᵢ highest frequency PRBs may originate for TPᵢ, while the Lⱼ lowest frequency PRBs and Pⱼ highest frequency PRBs may originate from TPⱼ. This is applicable based on fulfilling certain conditions such as the same PRS carrier configuration from both TPᵢ and TPⱼ.

The subcarrier delay measurement may be defined as

$$\frac{{\hat{θ}}_{low , L} - {\hat{θ}}_{high , L}}{12 N - ( \frac{12}{m} ) L} ,$$

where \hat{θ}_{low,L} is the average subcarrier phase measurement computed using the L lowest frequency PRS and \hat{θ}_{high,P} is the average subcarrier phase measurement computed using the P highest frequency PRS, N is the total number of configured PRS PRBs, m is the number of PRS per PRB, and Δω denotes the configured subcarrier spacing and provided that L=P.

Multiple DL PRS resources can be used to determine the average of one subcarrier phase measurement corresponding to the L lowest frequency PRBs or corresponding to the P highest frequency PRBs from a TP. In one implementation L=P, while in other implementations L≠P, depending on the configuration.

In an alternative implementation the Lᵢ lowest frequency PRBs and Pᵢ highest frequency PRBs may originate for TPᵢ, while the Lⱼ lowest frequency PRBs and Pⱼ highest frequency PRBs may originate from TPⱼ. This is applicable based on fulfilling certain conditions such as the same PRS carrier configuration from both TPᵢ and TPⱼ.

DL subcarrier phase difference and delay may be measured in RRC_CONNECTED, RRC_INACTIVE, or RRC_IDLE modes.

At 1425, the method may include transmitting a report of carrier phase measurements to a network entity. The operations of 1425 may be performed in accordance with examples as described herein. In some implementations, aspects of the operations of 1425 may be performed by a device as described with reference to FIG. 1. In an embodiment, a UE 104 transmits a report of its carrier phase measurements to a location server via a gNB.

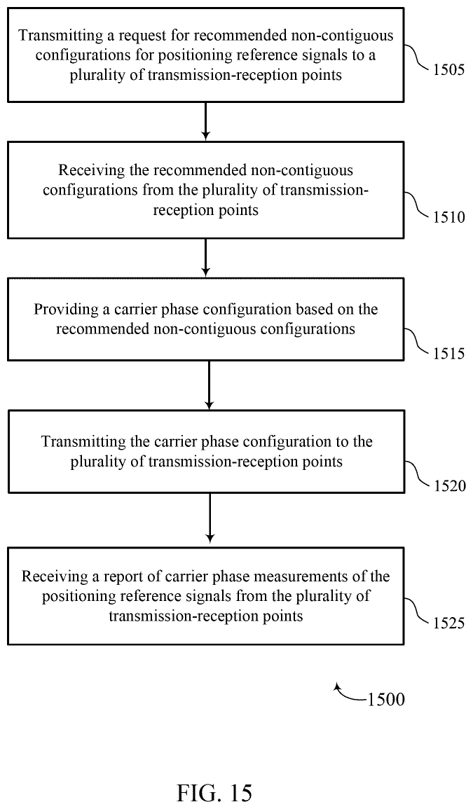

FIG. 15 illustrates a flowchart of a method 1500 that supports configuring and processing reference signals for carrier phase measurements in accordance with aspects of the present disclosure. The operations of method 1500 may be implemented by a device or its components as described herein. For example, the operations of method 1500 may be performed by a network entity 102, e.g. a location server, as described with reference to FIGS. 1 and 11. In some implementations, the device may execute a set of instructions to control the function elements of the device to perform the described functions. Additionally, or alternatively, the device may perform aspects of the described functions using special-purpose hardware.

At 1505, the method may include transmitting a request for recommended non-contiguous configurations for positioning reference signals to a plurality of transmission-reception points. The operations of 1505 may be performed in accordance with examples as described herein. In some implementations, aspects of the operations of 1505 may be performed by a device as described with reference to FIG. 1.

In one implementation, the location server may request a recommended non-contiguous PRS PRB configuration to a plurality of NG-RAN nodes, e.g., serving gNB/TRPs or neighbouring gNBs/TRPs, to perform carrier phase measurements, e.g., DL carrier phase measurements. The gNBs/TRPs may respond in a positive or negative manner to the corresponding location server request regarding the availability of a non-contiguous PRS PRB configuration at 1510 based on available radio resources at a given time.

If the response is positive, the gNBs/TRPs may send a plurality of non-contiguous PRS PRB configurations to the location server regarding its own gNB or set of TRPs. These procedures can be performed over the NRPPa interface and may use the applicable signalling, e.g., NRPPa TRP Information Request and TRP Information Response messages.

At 1515, the method may include providing a carrier phase configuration based on the recommended non-contiguous configurations. The operations of 1515 may be performed in accordance with examples as described herein. In some implementations, aspects of the operations of 1515 may be performed by a device as described with reference to FIG. 1.

The location server then collects the plurality of non-contiguous PRS PRB configurations from different gNB/TRPs to create a consolidated non-contiguous PRS PRB configuration at 1515. The consolidated configuration may comprise, among other elements, scheduling information as to which gNB/TRP will transmit the non-contiguous PRSs.

At 1520, the method may include transmitting the carrier phase configuration to the plurality of transmission-reception points. The operations of 1520 may be performed in accordance with examples as described herein. In some implementations, aspects of the operations of 1520 may be performed by a device as described with reference to FIG. 1.

In an embodiment, the location server 102 transmits the consolidated non-contiguous PRS PRB configuration to one or more UEs 104. In the case of UE-specific signalling, the LPP ProvideAssistanceData message may be used, while in the case of a broadcast to multiple UEs, a new posSIB (positioning system information broadcast) message may be employed to carry this configuration. Of course, other embodiments are possible.

At 1525, the method may include receiving a report of the carrier phase measurements of the positioning reference signals from the plurality of transmission-reception points. The operations of 1520 may be performed in accordance with examples as described herein. In some implementations, aspects of the operations of 1520 may be performed by a device as described with reference to FIG. 1. The report may include carrier phase measurements from UL or DL reference signals. The location server 102 may use the report to determine the location of a UE 104 using the carrier phase measurements.

It should be noted that the methods described herein describe possible implementations, and that the operations and the steps may be rearranged or otherwise modified and that other implementations are possible. Further, aspects from two or more of the methods may be combined.

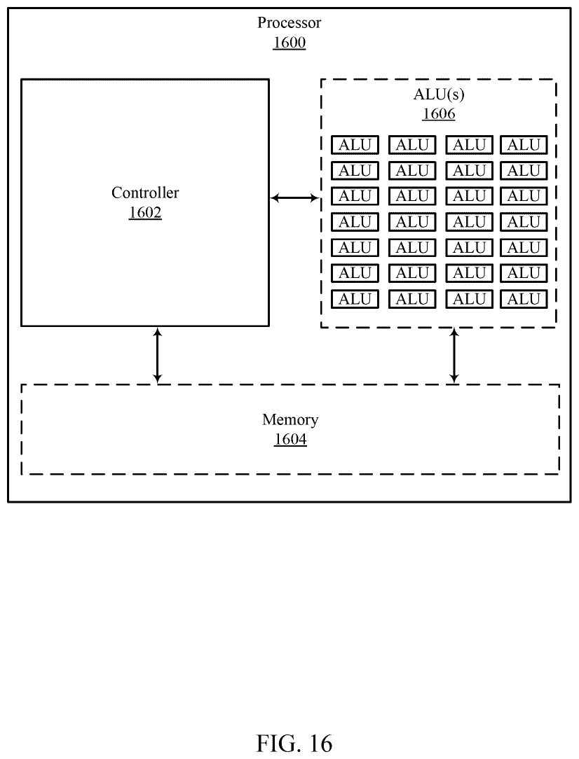

FIG. 16 illustrates an example of a processor 1600 that supports configuring and processing reference signals for carrier phase measurements in accordance with aspects of the present disclosure. The processor 1600 may be an example of a processor configured to perform various operations in accordance with examples as described herein. The processor 1600 may include a controller 1602 configured to perform various operations in accordance with examples as described herein. The processor 1600 may optionally include at least one memory 1604, such as L1/L2/L3 cache. Additionally, or alternatively, the processor 1600 may optionally include one or more arithmetic-logic units (ALUs) 1600. One or more of these components may be in electronic communication or otherwise coupled (e.g., operatively, communicatively, functionally, electronically, electrically) via one or more interfaces (e.g., buses).

The processor 1600 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 1600) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 1602 may be configured to manage and coordinate various operations (e.g., signaling, receiving, obtaining, retrieving, transmitting, outputting, forwarding, storing, determining, identifying, accessing, writing, reading) of the processor 1600 to cause the processor 1600 to support various operations in accordance with examples as described herein. For example, the controller 1602 may operate as a control unit of the processor 1600, generating control signals that manage the operation of various components of the processor 1600. These control signals include enabling or disabling functional units, selecting data paths, initiating memory access, and coordinating timing of operations.

The controller 1602 may be configured to fetch (e.g., obtain, retrieve, receive) instructions from the memory 1604 and determine subsequent instruction(s) to be executed to cause the processor 1600 to support various operations in accordance with examples as described herein. The controller 1602 may be configured to track memory address of instructions associated with the memory 1604. The controller 1602 may be configured to decode instructions to determine the operation to be performed and the operands involved. For example, the controller 1602 may be configured to interpret the instruction and determine control signals to be output to other components of the processor 1600 to cause the processor 1600 to support various operations in accordance with examples as described herein. Additionally, or alternatively, the controller 1602 may be configured to manage flow of data within the processor 1600. The controller 1602 may be configured to control transfer of data between registers, arithmetic logic units (ALUs), and other functional units of the processor 1600.

The memory 1604 may include one or more caches (e.g., memory local to or included in the processor 1600 or other memory, such RAM, ROM, DRAM, SDRAM, SRAM, MRAM, flash memory, etc. In some implementations, the memory 1604 may reside within or on a processor chipset (e.g., local to the processor 1600). In some other implementations, the memory 1604 may reside external to the processor chipset (e.g., remote to the processor 1600).

The memory 1604 may store computer-readable, computer-executable code including instructions that, when executed by the processor 1600, cause the processor 1600 to perform various functions described herein. The code may be stored in a non-transitory computer-readable medium such as system memory or another type of memory. The controller 1602 and/or the processor 1600 may be configured to execute computer-readable instructions stored in the memory 1604 to cause the processor 1600 to perform various functions. For example, the processor 1600 and/or the controller 1602 may be coupled with or to the memory 1604, and the processor 1600, the controller 1602, and the memory 1604 may be configured to perform various functions described herein. In some examples, the processor 1600 may include multiple processors and the memory 1604 may include multiple memories. One or more of the multiple processors may be coupled with one or more of the multiple memories, which may, individually or collectively, be configured to perform various functions herein.

The one or more ALUs 1600 may be configured to support various operations in accordance with examples as described herein. In some implementations, the one or more ALUs 1600 may reside within or on a processor chipset (e.g., the processor 1600). In some other implementations, the one or more ALUs 1600 may reside external to the processor chipset (e.g., the processor 1600). One or more ALUs 1600 may perform one or more computations such as addition, subtraction, multiplication, and division on data. For example, one or more ALUs 1600 may receive input operands and an operation code, which determines an operation to be executed. One or more ALUs 1600 be configured with a variety of logical and arithmetic circuits, including adders, subtractors, shifters, and logic gates, to process and manipulate the data according to the operation. Additionally, or alternatively, the one or more ALUs 1600 may support logical operations such as AND, OR, exclusive-OR (XOR), not-OR (NOR), and not-AND (NAND), enabling the one or more ALUs 1600 to handle conditional operations, comparisons, and bitwise operations.

The processor 1600 may support wireless communication in accordance with examples as disclosed herein. The processor 1600 may be configured to or operable to support a means for configuring and processing reference signals for carrier phase measurements.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

Any connection may be properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The terms “transmitting,” “receiving,” or “communicating,” when referring to a network entity, may refer to any portion of a network entity (e.g., a base station, a CU, a DU, a RU) of a RAN communicating with another device (e.g., directly or via one or more other network entities).

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form to avoid obscuring the concepts of the described example.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A user equipment (UE) for wireless communication, comprising:
at least one memory, and
at least one processor coupled with the at least one memory and configured to cause the UE to:
receive a carrier phase configuration from a network entity, the carrier phase configuration including parameters for a plurality of non-contiguous positioning reference signals;
receive the plurality of non-contiguous positioning reference signals;
measure carrier phase of the plurality of non-contiguous positioning reference signals; and
transmit the carrier phase measurements to the network entity.

2. The UE of claim 1, wherein the carrier phase measurements comprise at least one of a subcarrier phase difference, and a delay based on a subcarrier phase difference.

3. The UE of claim 1, wherein the carrier phase configuration indicates an outermost set of positioning reference signal pairs within a bandwidth in which carrier phase is measured.

4. The UE of claim 3, wherein the outermost set of positioning reference signal pairs includes a pair of physical resource blocks (PRBs) at a highest frequency and a lowest frequency of the bandwidth.

5. The UE of claim 3, wherein the carrier phase configuration further indicates an innermost set of positioning reference signal pairs within the bandwidth in which carrier phase is measured.

6. The UE of claim 5, wherein the innermost set of positioning reference signal pairs are spaced apart from the outermost set of positioning reference signal pairs in the frequency domain.

7. The UE of claim 3, wherein the carrier phase configuration indicates a frequency separation between the outermost set of positioning reference signal pairs.

8. The UE of claim 5, wherein the frequency separation between the innermost sets of positioning reference signals is at least ⅓ of the frequency separation between the outermost sets of positioning reference signals.

9. The UE of claim 1, wherein the carrier phase configuration includes an indication to measure carrier phase of positioning reference signals received simultaneously from at least two different transmitters.

10. A method performed by a user equipment (UE), the method comprising:
receiving a carrier phase configuration from a network entity, the carrier phase configuration including parameters for a plurality of non-contiguous positioning reference signals;
receiving the plurality of non-contiguous positioning reference signals;
measure carrier phase of the plurality of non-contiguous positioning reference signals; and
transmitting the carrier phase measurements to the network entity.

11. The method of claim 10, wherein the carrier phase measurements comprise at least one of a subcarrier phase difference, and a delay based on a subcarrier phase difference.

12. The method of claim 10, wherein the carrier phase configuration indicates an outermost set of positioning reference signal pairs within a bandwidth in which carrier phase is measured.

13. The method of claim 12, wherein the outermost set of positioning reference signal pairs includes a pair of physical resource blocks (PRBs) at a highest frequency and a lowest frequency of the bandwidth.

14. The method of claim 12, wherein the carrier phase configuration further indicates an innermost set of positioning reference signal pairs within the bandwidth in which carrier phase is measured.

15. The method of claim 14, wherein the innermost set of positioning reference signal pairs are spaced apart from the outermost set of positioning reference signal pairs in the frequency domain.

16. The method of claim 12, wherein the carrier phase configuration indicates a frequency separation between the outermost set of positioning reference signal pairs.

17. The method of claim 14, wherein the frequency separation between the innermost sets of positioning reference signals is at least ⅓ of the frequency separation between the outermost sets of positioning reference signals.

18. The method of claim 10, wherein the carrier phase configuration includes an indication to measure carrier phase of positioning reference signals received simultaneously from at least two different transmitters.

19. A user equipment (UE), comprising:
at least one memory; and
at least one processor coupled with the at least one memory and configured to cause the UE to:
receive a carrier phase configuration from a network entity, the carrier phase configuration including parameters to configure a plurality of positioning reference signals in a non-contiguous manner;
receive a plurality of carrier phase measurements based on the received carrier phase configuration; and
transmit a report of the received carrier phase measurements to the network entity.

20. A network entity for wireless communication comprising:
at least one memory; and
at least one processor coupled with the at least one memory and configured to cause the network entity to:
transmit a request for recommended non-contiguous configurations for positioning reference signals to a plurality of transmission-reception points;
receive the recommended non-contiguous configurations from the plurality of transmission-reception points;
provide a carrier phase configuration based on the recommended non-contiguous configurations;
transmit the carrier phase configuration to the plurality of transmission-reception points; and
receive a report of carrier phase measurements of the positioning reference signals from the plurality of transmission-reception points.
